(19) United States
(12) Patent Application Publication
(10) Pub. No.: US 2010/0040007 A1
(43) Pub. Date: Feb. 18, 2010

(54) Wireless Communication Device, Communication System, and Communication Control Method, and Program

(76) Inventors: Takeshi ITAGAKI, Tokyo (JP); Katsutoshi Itoh, Tokyo (JP); Masahiko Naito, Tokyo (JP); Osamu Yoshimura, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/539,401

(22) Filed: Aug. 11, 2009

(30) Foreign Application Priority Data
Aug. 14, 2008 (JP) P2008-208843

(51) Int. Cl. H04W 4/00

(52) U.S. Cl. 370/329

(57) ABSTRACT

A wireless communication device includes a control unit for performing a processing on communication data and a memory storing the communication data, in which the control unit performs a processing on data received via a direct link path and a path via a relay point, stores the data received via the respective paths in plural reorder buffers corresponding to the communication paths set in the memory, after a communication path switch decision processing, stores data from a new channel in a new channel reorder buffer and prohibits transfer to a higher-level layer, and when data indicating a trailing end frame is received from an existing channel, or a stand-by time elapses, or the data stored in the reorder buffer for the new channel reaches a specified threshold, performs a transfer processing for the data stored in the reorder buffer for the new channel to the higher-level layer.

### BACKGROUND OF THE INVENTION

1. Field of the Invention

The present invention relates to a wireless communication device, a communication system, and a communication control method, and a program. In particular, the invention relates to a wireless communication device configured to carry out a communication in which both a communication via an access point and a direct communication without intermediation of the access point are utilized, a communication system, and a communication control method, and a program.

2. Description of the Related Art

Wireless LAN protocols (802.11) regulate an ad-hoc mode in which a direct communication is carried out between wireless communication devices and an infrastructure mode as a communication mode in which a communication is carried via an access point.

In the infrastructure mode in which the communication is carried out via the access point, the access point which performs a communication relay conciliates access timings of a plurality of wireless communication devices existing in a wireless network. On the other hand, in the ad-hoc mode in which the direct communication is carried out between the wireless communication devices, the direct communication is carried out between the wireless communication devices to decide the access timings between the wireless communication devices. The related art technology disclosing these communication modes includes, for example, Japanese Unexamined Patent Application Publication No. 2005-117458.

The infrastructure mode in which the communication is carried via the access point has a disadvantage that the throughput is decreased as compared with the ad-hoc mode but has an advantage that the respective wireless terminals serving under can be connected to a wired LAN or the internet. As the wireless terminals directly communicate with each other, the ad-hoc mode on the other hand has an advantage that an overhead based on the access point relay does not exist and the throughput is increased but has a disadvantage that the wireless terminals are not connected to a wired LAN or the internet.

As a new communication method with which it is possible to utilize the respective advantages of these two modes, a TDLS (Tunneled Direct Link Setup) method is being defined as a new protocol 802.11z. According to this method, a direct communication link for the mutual wireless terminals (direct link) is set while the infrastructure mode is maintained, and the direct communication can be carried out. Also, a mechanism is also proposed in which after the direct link is set, the paths used for the sending to a communication party (the path via the access point and the direct link path) are appropriately switched as the occasion demands.

However, if the path switch is performed between the path via the access point and the direct link path while the communication is executed between two communication devices, a case may occur in which before a data frame sent via an old channel (path) is delivered, a data frame sent via a new channel is delivered to the communication party earlier. It should be noted that a frame is synonymous with a packet and has a meaning of a data communication unit.

When the data frame sent via the new channel is delivered to the communication party earlier than the data frame sent via the old channel (path), the order of reception frames in a data reception device collapses, and a normal data communication is impaired. This phenomenon is generated, for example, due to relay delay via the access point, the resending queue because of deterioration in transmission characteristics in the old channel, or the like.

The deviation in the order of the reception frames due to the path switch will be described with reference to FIG. 1. FIG. 1 shows, from the left, a wireless communication device (STA1) functioning as a data sending terminal, an access point (AP) configured to perform a communication relay processing, and a wireless communication device (STA2) functioning as a data receiving terminal.

The wireless communication device (STA1) executes, first, a communication with the wireless communication device (STA2) via the access point (AP), and thereafter, by setting the direct link, without intermediation of the access point (AP), a direct communication between the wireless communication device (STA1) and the wireless communication device (STA2) is carried out.

Numerals assigned to the side of the sending of the respective data frames (=packets) represents the sending order of the packets from the wireless communication device (STA1). The wireless communication device (STA1) first sends packets 1, 2, and 3 via the access point (AP) to the wireless communication device (STA2). After that, by setting the direct link, without intermediation of the access point (AP), the wireless communication device (STA1) sends packets 4, 5, and 6 to the wireless communication device (STA2).

In a case where such data sending is executed, for example, if the delay is generated at the relay path via the access point (AP), such a situation occurs that as in the order of the received packets by the wireless communication device (STA2) shown in the drawing, the packets 4, 5, and 6 sent after the switch to the direct link path is effected are delivered to the wireless communication device (STA2) earlier, and the packets 1, 2, and 3 previously sent are received later. Thus, an order property of the frames collapses.

As a technology for dealing with such a problem in the related art, for example, one measure has been taken in the standardization of 802.11s. This measure is for assigning running sequence numbers regulating the packet order corresponding to the sent packets to a header at a level still higher than the normal MAC header. However, according to this method, in addition to the normal sequence number assignment to the MAC header, a new sequence number is also assigned, and there is a problem that a processing load in the communication device is increased, which leads to a decrease in communication efficiency.

### SUMMARY OF THE INVENTION

The present invention has been made, for example, in view of the above-mentioned problem, and it is desirable to provide a wireless communication device, a communication system, and a communication control method, and a program, in which in a configuration where a communication is carried out accompanying a path switch between a path via an access point (AP) and a direct link path between communication devices, a deviation of an order in reception data due to the path switch can be eliminated.

According to an embodiment of the present invention, there is provided a wireless communication device, including: a control unit configured to perform a processing on communication data; and a memory storing the communication data, in which the control unit has a configuration of performing a processing on data received via a direct link path functioning as a direct communication path with a communication other party and a path via a relay point functioning as a communication path via the relay point, and the control unit stores the data received via the respective communication paths in a plurality of reorder buffers corresponding to the communication paths set in the memory, after a communication path switch decision processing, stores data received from a new channel in a reorder buffer for the new channel and performs a processing of prohibiting transfer of the data to a higher-level layer, and on condition that data indicating a trailing end frame is received from an existing channel, or a stand-by time elapses, or the data stored in the reorder buffer for the new channel reaches a specified threshold, performs a transfer processing for the data stored in the reorder buffer for the new channel to the higher-level layer.

Furthermore, in the wireless communication device according to a further embodiment of the present invention, before the transfer processing for the data stored in the reorder buffer for the new channel to the higher-level layer is started, the control unit executes a transfer processing for data stored in a reorder buffer for the existing channel to the higher-level layer.

Furthermore, in the wireless communication device according to a further embodiment of the present invention, as the communication path switch processing, the control unit sends an acceptance reply to a communication path switch request from the communication other party.

Furthermore, in the wireless communication device according to a further embodiment of the present invention, as the communication path switch processing, the control unit sends a communication path switch request to the communication other party and receives an acceptance reply.

Furthermore, in the wireless communication device according to a further embodiment of the present invention, as a processing in a MAC layer, the control unit executes a data storage processing with respect to the plurality of reorder buffers corresponding to the communication paths while following a sequence number in the MAC header included in the received data.

Furthermore, in the wireless communication device according to a further embodiment of the present invention, as a processing in an LLC layer, the control unit further executes data storage with respect to a reorder buffer corresponding to the LLC layer while following communication path information included in the received data.

Furthermore, in the wireless communication device according to a further embodiment of the present invention, the control unit measures an overtaking amount of communication data utilizing the new channel with respect to communication data utilizing the existing channel and sets a data amount comparable to the measured overtaking amount as the specified threshold for the data stored in the reorder buffer for the new channel.

Furthermore, in the wireless communication device according to a further embodiment of the present invention, the control unit sends an echo request frame in which a communication route is specified as a measurement processing of the overtaking amount of the communication data.

Furthermore, in the wireless communication device according to a further embodiment of the present invention, the data indicating the trailing end frame from the existing channel is a frame in which trailing end information is stored in an expansion header, and the control unit performs a check processing as to whether or not a frame is the frame in which the trailing end information is stored in the expansion header.

Furthermore, in the wireless communication device according to a further embodiment of the present invention, the data indicating the trailing end frame from the existing channel is a frame in which trailing end information is stored in an EOSP bit in a QoS control field of the 802.11 MAC header, and the control unit performs a check processing as to whether or not a frame is the frame in which the trailing end information is stored in the EOSP bit.

Furthermore, in the wireless communication device according to a further embodiment of the present invention, in a case where the data received from the new channel is detected, the control unit executes a transfer processing for data stored in a reorder buffer for the existing channel to the higher-level layer and a processing of discarding data received thereafter from the existing channel.

In addition, according to another embodiment of the present invention, there is provided a communication system including a plurality of wireless communication devices configured to perform data sending and reception, in which the plurality of wireless communication devices which perform a communication processing mutually execute sending and reception of a communication path switch request and an acceptance reply to perform a communication path switch decision, and the wireless communication device which performs the data reception stores the data received via respective communication paths in a plurality of reorder buffers corresponding to the communication paths set in a memory, after a communication path switch decision processing, stores data received from a new channel in a reorder buffer for the new channel and performs a processing of prohibiting transfer of the data to a higher-level layer, and on condition that data indicating a trailing end frame is received from an existing channel, or a stand-by time elapses, or the data stored in the reorder buffer for the new channel reaches a specified threshold, performs a transfer processing for the data stored in the reorder buffer for the new channel to the higher-level layer.

In addition, according to another embodiment of the present invention, there is provided a communication control method executed in a wireless communication device, the method including the step of: performing by a control unit a processing on data received via a direct link path functioning as a direct communication path with a communication other party and a path via a relay point functioning as a communication path via the relay point, the received data processing step including the steps of storing the data received via the respective communication paths in a plurality of reorder buffers corresponding to the communication paths set in the memory, after a communication path switch decision processing, storing data received from a new channel in a reorder buffer for the new channel and performing a processing of prohibiting transfer of the data to a higher-level layer, and on condition that data indicating a trailing end frame is received from an existing channel, or a stand-by time elapses, or the data stored in the reorder buffer for the new channel reaches a specified threshold, performing a transfer processing for the data stored in the reorder buffer for the new channel to the higher-level layer.

In addition, according to another embodiment of the present invention, there is provided a program for executing a processing on communication data in a wireless communication device, the program including the step of: instructing a control unit to perform a processing on data received via a direct link path functioning as a direct communication path with a communication other party and a path via a relay point functioning as a communication path via the relay point, the received data processing step including the steps of storing the data received via the respective communication paths in a plurality of reorder buffers corresponding to the communication paths set in the memory, after a communication path switch decision processing, storing data received from a new channel in a reorder buffer for the new channel and performing a processing of prohibiting transfer of the data to a higher-level layer, and on condition that data indicating a trailing end frame is received from an existing channel, or a stand-by time elapses, or the data stored in the reorder buffer for the new channel reaches a specified threshold, performing a transfer processing for the data stored in the reorder buffer for the new channel to the higher-level layer.

It should be noted that the program according to the embodiment of the present invention is, for example, a program which is provided in a computer-readable format and can be provided on a storage medium or a communication medium with respect to a general-use system capable to executing various program codes. By providing such a program in the computer-readable format, a processing in accordance with the program is realized on a computer system.

Further features and advantages of the present invention will become apparent from the following detailed description of exemplary embodiments with reference to the attached drawings. It should be noted that the system mentioned in the present specification is a logical collective structure of a plurality of devices and is not limited to a system in which the devices of the respective components are installed in the same package.

According to the embodiment of the present invention, in the communication device which performs the processing on the data received via the direct link path functioning as the direct communication path with the communication other party and the path via the relay point functioning as the communication path via the relay point, the pieces of the received data via the respective communication paths are stored in the plurality of reorder buffers corresponding to the communication path set in the memory. Furthermore, after the communication path switch decision processing, the transfer of the data stored in the reorder buffer for the new channel to the higher-level layer is prohibited. After that, on condition that the data indicating the trailing end frame is received from the existing channel, or the stand-by time elapses, or the data stored in the reorder buffer for the new channel reaches the specified threshold, the transfer processing for the data stored in the reorder buffer for the existing channel to the higher-level layer is executed, and thereafter, the transfer processing for the data stored in the reorder buffer for the new channel to the higher-level layer is performed. With the present configuration, the higher-level layer can receive the data in the order matched with the order of the sending data.

### BRIEF DESCRIPTION OF THE DRAWINGS

FIG. 1 is an explanatory diagram for describing a deviation of an order in received packets due to a path switch;

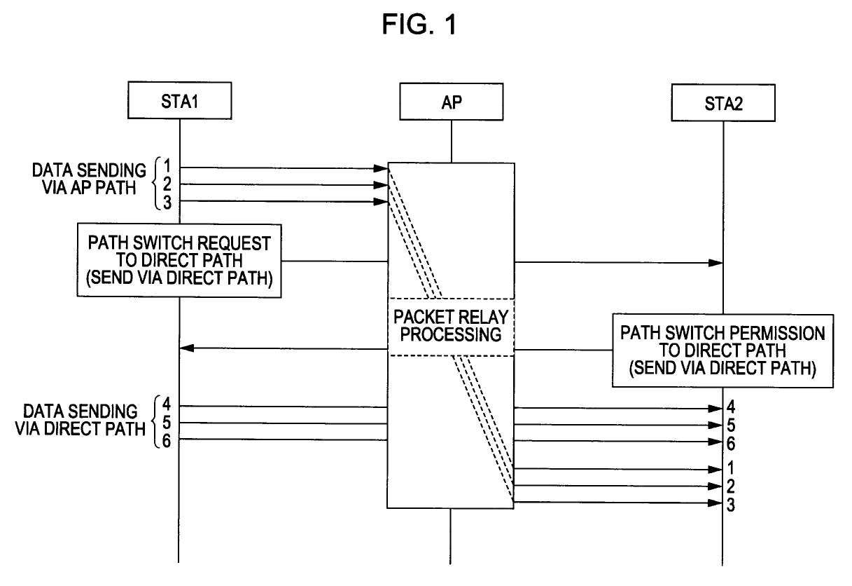

FIG. 2 is an explanatory diagram for describing a wireless communication system according to an embodiment of the present invention;

FIG. 3 shows a configuration example of a wireless communication device according to an embodiment of the present invention;

FIG. 4 shows a configuration example of a communication packet according to an embodiment of the present invention;

FIG. 5 is an explanatory diagram for describing an outline of a communication processing sequence according to an embodiment of the present invention;

FIG. 6 is a flow chart for describing a communication sequence and a processing between the respective devices in a DLS registration processing according to an embodiment of the present invention;

FIG. 7 is an explanatory diagram for describing a communication sequence and a processing performed between the respective devices in an existing channel trailing end data sending processing according to an embodiment of the present invention;

FIG. 8 is an explanatory diagram for describing a communication sequence and a processing performed between the respective devices in a channel switch request/response processing according to an embodiment of the present invention;

FIG. 9 is an explanatory diagram for describing a communication sequence and a processing performed between the respective devices in a path-in-use switch processing according to an embodiment of the present invention;

FIG. 10 is an explanatory diagram for describing a communication sequence and a processing performed between the respective devices in a transient state buffer control processing according to an embodiment of the present invention;

FIG. 11 is an explanatory diagram for describing an example of a sending state of the packets performed in a channel switch processing according to an embodiment of the present invention;

FIG. 12 is an explanatory diagram for describing an example of a rearrangement processing for the packet order through a transient state buffer control processing performed in the channel switch processing according to an embodiment of the present invention;

FIG. 13 is an explanatory diagram for describing an outline of a communication processing sequence according to an embodiment of the present invention;

FIG. 14 is an explanatory diagram for describing a communication sequence and a processing performed between the respective devices in the channel switch processing according to an embodiment of the present invention;

FIG. 15 shows a configuration example of a communication packet according to an embodiment of the present invention;

FIG. 16 is an explanatory diagram for describing a communication sequence and a processing performed between the respective devices in the existing channel trailing end data sending processing according to an embodiment of the present invention;

FIG. 17 is an explanatory diagram for describing a communication sequence and a processing performed between the respective devices in the transient state buffer control processing according to an embodiment of the present invention;

FIG. 18 is an explanatory diagram for describing an estimation processing for a data transfer time by using “route specification echo request/response” frames according to an embodiment of the present invention;

FIG. 19 is an explanatory diagram for describing an example of a channel update decision processing to which the “route specification echo request” frame and the “route specification echo response” frame are applied; and

FIG. 20 is an explanatory diagram for describing a communication sequence and a processing performed between the respective devices in the transient state buffer control processing according to an embodiment of the present invention.

### DESCRIPTION OF THE PREFERRED EMBODIMENTS

Hereinafter, with reference to the drawings, details of a wireless communication device, a communication system, and a communication control method, and a program according to an embodiment of the present invention will be described.

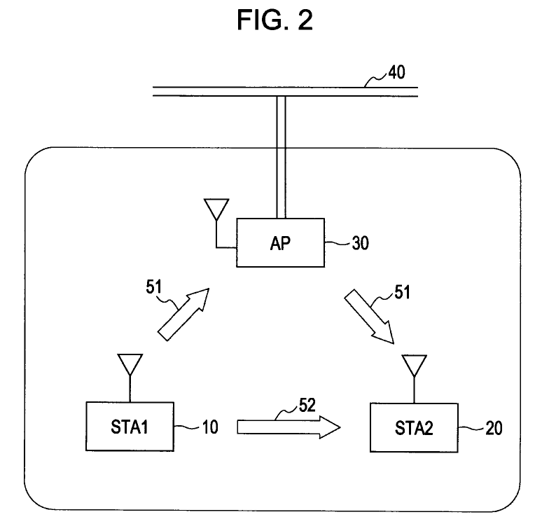

A wireless communication system according to an embodiment of the present invention will be described with reference to FIG. 2. FIG. 2 shows a wireless communication device (STA1) 10 and a wireless communication device (STA2) 20 which are two wireless terminals configured to carry out a data communication, and further an access point (AP) 30 configured to execute a communication relay processing between the wireless communication devices.

It suffices that the access point (AP) 30 may have a general configuration as in the related art and does not use a special function. The wireless communication device (STA1) 10 and the wireless communication device (STA2) 20 have a direct link channel setting function in addition to normal operations of the wireless LAN according to an embodiment of the present invention. The wireless communication device (STA1) 10 and the wireless communication device (STA2) 20 complete association as a connection request to the access point (AP) 30, and a path 51 via the AP connecting the wireless communication device (STA1) 10 shown in FIG. 2 via the access point (AP) 30 to the wireless communication device (STA2) 20 can be used.

Hereinafter, according to the embodiment to be described, the wireless communication device (STA1) 10 is set to be on a data sending side, and the wireless communication device (STA2) 20 is set to be on a data receiving side. When a processing of DLS (Direct Link Set-up) is completed as a set-up processing for carrying out a direct communication between the wireless communication devices, a direct link path 52 which directly connects the wireless communication device (STA1) 10 with the wireless communication device (STA2) 20 shown in FIG. 2 can be used.

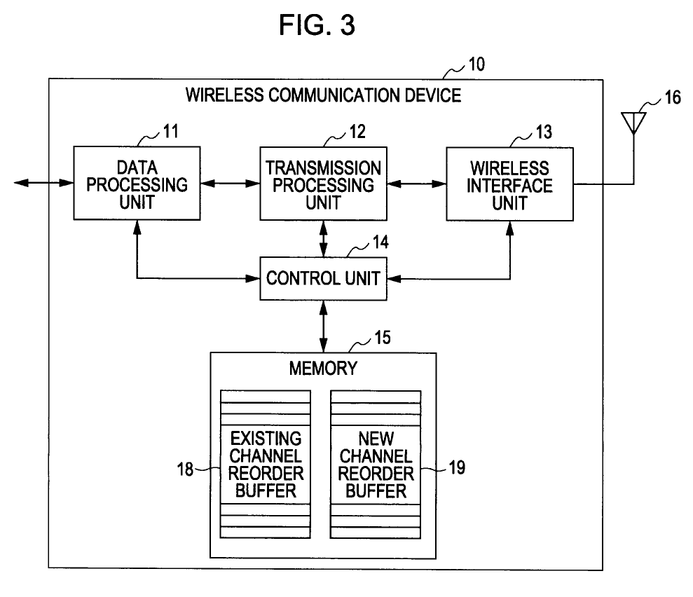

FIG. 3 is a block diagram of a configuration of the wireless communication device (STA1) 10 shown in FIG. 2. It should be noted that the wireless communication device (STA2) 20 also has a common configuration. As shown in FIG. 3, the wireless communication device 10 includes a data processing unit 11, a transmission processing unit 12, a wireless interface unit 13, a control unit 14, a memory 15, and an antenna 16.

The data processing unit 11 creates a packet which stores communication data. The transmission processing unit 12 performs a processing such as addition of a header an error detection sign to the packet created in the data processing unit 11 and provides the data after the processing to the wireless interface unit 13. The wireless interface unit 13 converts the data received from the transmission processing unit 12 into a modulation signal to be sent via the antenna 16.

In a data reception operation, the wireless interface unit 13 performs demodulation of the received signal with respect to the data received via the antenna 16, and the transmission processing unit 12 performs header analysis and provides the data to the data processing unit 11. The data processing unit 11 obtains the communication data from the packet. The control unit 14 performs an overall control for the processing of the respective components described above. Also, the control unit 14 obtains the data stored in the memory 15 and provides the data to the data processing unit 11 for preparing packet storage data. Alternatively, the control unit 14 stores the data obtained from the packet by the data processing unit 11 in the memory 15. The memory 15 stores a program for a communication control in addition to the communication data, and the control unit 14 executes the communication control following the program.

In the memory 15, a reorder buffer 18 for the existing channel and a reorder buffer 19 for the new channel are constructed. A reorder buffer is a buffer for carrying out storage in the sequence order by arranging the packet order, for example, in the sequence order set in MAC headers of the packets. Under a control of the control unit 14, the storage is carried out in the sequence order set in the MAC headers of the received packets.

The device according to the embodiment of the present invention has, as shown in the drawing, the reorder buffer 18 for the existing channel and the reorder buffer 19 for the new channel. That is, the individual reorder buffers corresponding to the communication paths are constructed.

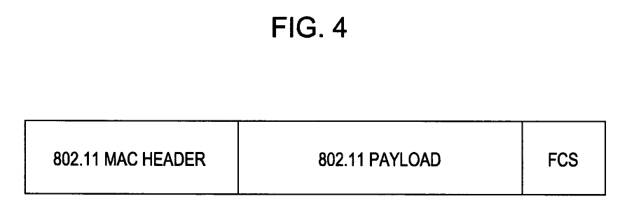

The packet (frame) sent and received by the wireless communication device has, for example, a configuration shown in FIG. 4. As shown in FIG. 4, the packet has the MAC header, payload, and FCS (frame check sequence). The MAC header contains a sequence number functioning as a sending packet order set in units of an address of the respective sending devices (respective communication channels (paths)), and the like. The payload is an actual data storage unit which becomes a target of the sending and receiving. The FCS (frame check sequence) contains an error correction code and the like, and stores data utilized for a correction processing of the frame data and the like.

The sequence number set in the MAC header is set by a device which carries out the data sending. For example, in the configuration shown in FIG. 2, in a case where the wireless communication device (STA2) 20 receives data from the wireless communication device (STA1) 10 via the direct link path 52, a sequence number set by the wireless communication device (STA1) 10 to the MAC header is set in the received packet. Also, in a case where the data reception through the path 51 via the AP is carried out from the wireless communication device (STA1) 10 via the access point (AP) 30, the sequence number set in the MAC header by the access point (AP) 30 is set in the received packet.

The sequence number set in the MAC header by the access point (AP) 30 does not have relevance to the sequence number set in the MAC header by the wireless communication device (STA1) 10. Therefore, even when the sequence numbers set in the MAC headers of the packets received from the two paths are used, the original order is not identified.

The wireless communication device according to the embodiment of the present invention sets the reorder buffer inherent to the path and certainly maintains the packet order in units of the addresses of the respective sending devices (respective communication channels (paths)). Furthermore, through the processing which will be described below, the wireless communication device can provide the data to higher-level application or the like without disrupting the original order of the received data from a plurality of channels (paths).

To be more specific, the control unit of the wireless communication device according to the embodiment of the present invention stores, for example, the data received via the respective communication paths in a plurality of reorder buffers corresponding to a communication path set in the memory, after the communication path switch decision processing, stores data received from a new channel in a reorder buffer for the new channel, and performs a processing of prohibiting transfer of the data to a higher-level layer, and on condition that data indicating a trailing end frame is received from an existing channel, or a stand-by time elapses, or the data stored in the reorder buffer for the new channel reaches a specified threshold, the control unit performs a transfer processing for the data stored in the reorder buffer for the new channel to the higher-level layer.

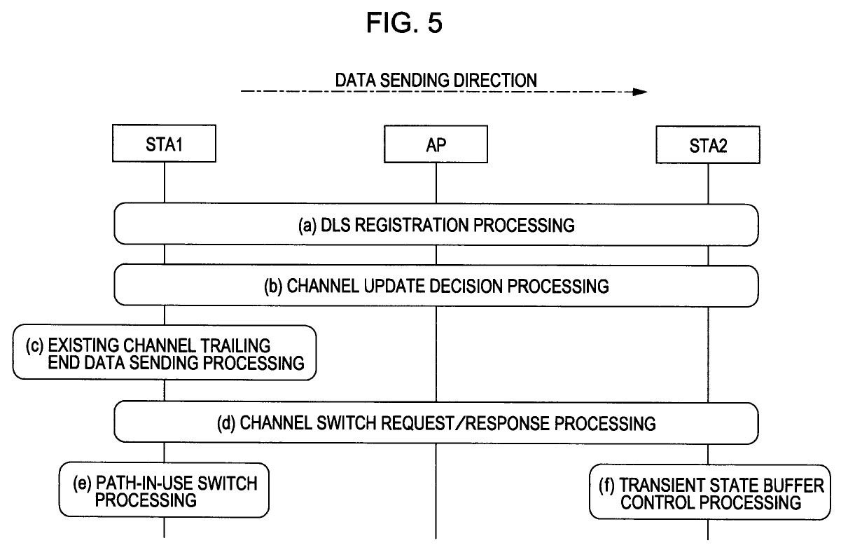

An outline of the communication processing sequence according to the embodiment of the present invention will be described with reference to FIG. 5. It should be noted that in the following description, the wireless communication device (STA1) which performs the data sending is abbreviated as “the STA1”, and the wireless communication device (STA2) which performs the data reception is abbreviated as “the STA2”.

As shown in FIG. 5, in the communication sequence following the embodiment of the present invention, the packets are subjected to the following processings.
(a) A DLS registration processing
(b) A channel update decision processing

Through these two processing, the communication channel (path) switch is decided, and thereafter, the following processings are performed.
(c) An existing channel trailing end data sending processing (sending side)
(d) A channel switch request/response processing
(e) A path-in-use switch processing (sending side)
(f) A transient state buffer control processing (receiving side)

Through these processings, the path switch is completed. It should be noted that these processings are performed under the control of the control unit in the wireless communication device.

(a) The DLS registration processing is a set-up processing for performing a direct communication between the wireless communication devices. In this DLS registration processing, the wireless communication devices executing the direct communication (STA1 and the STA2 in the present example) capsulate information such as capability of its own device and mutually exchange the capsules to register the communication other party via the direct link.

When this DLS registration processing is completed, the STA1 selectively utilize both the path via the AP and the direct link path so as to be able to perform data sending to the STA2.

(b) The channel update decision processing is a processing of determining which path is suitable to be used for the communication with the other party's terminal by using the information related to the transmission quality of the direct link path separately monitored and the information related to the transmission quality of the path via the AP and deciding the path update with respect to the more appropriate path.

(c) The existing channel trailing end data sending processing (sending side) is a processing of notifying the reception side that this is the last data sent by the data sending side by using the existing channel.

(d) The channel switch request/response processing is a processing in which the data sending side shows an intention to change the channel used for the data sending and receives a response from the reception side.

(e) The path-in-use switch processing (sending side) is a processing in which the data sending side actually switches the channel used for the data sending and starts to send the data in a new channel in response to the path switch acceptance reply from the data reception side.

(f) The transient state buffer control processing (receiving side) is a transient processing in which the reception side accepting the path switch determines that the last data using the existing channel arrives and the channel is completely switched until start of an operation of transferring the received data in the new channel to the higher-level layer as the normal operation.

Hereinafter, specific embodiments of the present invention will be described.

### 1. First Embodiment

Hereinafter, the following respective processings according to a first embodiment of the present invention will be described.
(a) The DLS registration processing
(b) The channel update decision processing
(c) The existing channel trailing end data sending processing (sending side)
(d) The channel switch request/response processing
(e) The path-in-use switch processing (sending side)
(f) The transient state buffer control processing (receiving side)

1a. The DLS Registration Processing

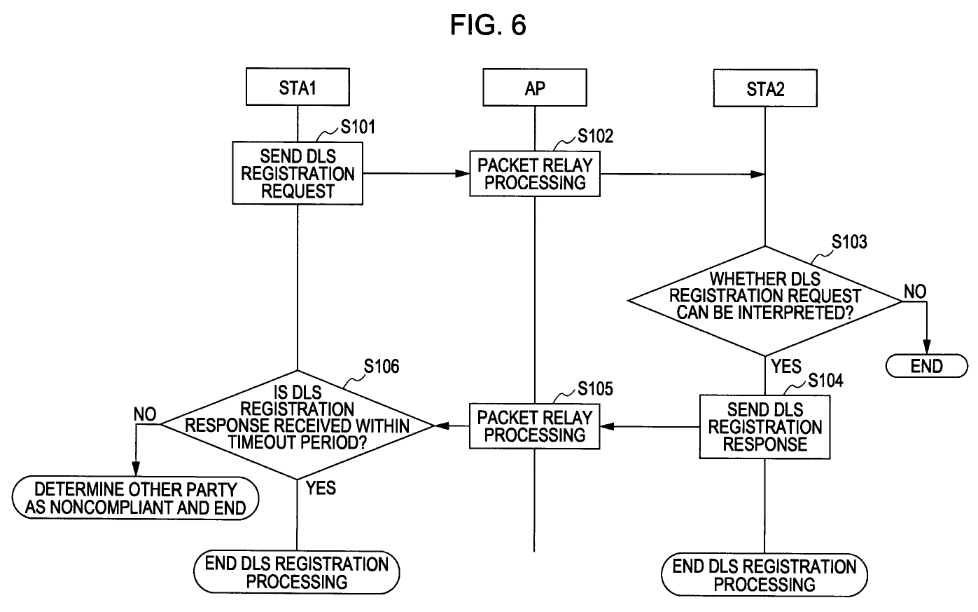

FIG. 6 is a flow chart for describing the communication sequence between the devices in the DLS registration processing according to the present embodiment and the processing. From the left, the following devices are illustrated.

The wireless communication device (STA1) functioning as the data sending terminal;

The access point (AP) functioning as the communication relay device; and

The wireless communication device (STA2) functioning as the data receiving terminal.

The DLS registration processing is the set-up processing for performing a direct communication between the wireless communication devices. At the time of the DLS registration processing, the direct link setting request and response are sent and received between the wireless communication devices. To be more specific, the frame applied to this processing is not a management frame, but is the data frame including the signaling information at a higher-level layer than the 802.11 MAC layer. Via the access point (AP), the frame for the DLS registration processing is sent and received. The relaying access point (AP) is not conscious about the contents of the frame, and the processing is completed between the two STAs.

First, in step S101, the STA1 functioning as the data sending side terminal sends a “DLS registration request” frame including information on the device capability of the STA1 to the STA2 functioning as the data receiving side terminal.

This frame is relayed by the access point (AP) to arrive at the STA2. If the STA2 receiving the frame can interpret the content of this frame (Yes in step S103), the flow advances to step S104, and the “DLS registration response” frame is similarly returned via the AP to the STA1. The present frame is a unique frame, and the frame includes information on the device capability of the STA2. Furthermore, the frame includes direct link set-up availability information in the STA2, that is, a success and failure field recording DLS success and failure information.

In a case where the STA2 is a device which does not correspond to the DLS, the contents of the DLS registration request frame received from the STA1 is not interpreted (No in step S103). In this case, the DLS registration request frame received from the STA1 is discarded in the STA2, and the processing is ended.

After the STA2 succeeds the interpretation of the “DLS registration request” frame received from the STA1 in step S104, the “DLS registration response” frame sent to the STA1 arrives at the STA1 via the AP (step S105).

IF the STA1 can receive the “DLS registration response” frame and interpret the contents (Yes in step S106), and further a value of the success and failure field of the received frame indicates “DLS registration success”, the DLS setting is completed.

In a case where the STA1 does not receive the DLS registration response frame from the STA2 in a previously set timeout period, it is determined that the other party does not correspond to the DLS, the direct link is not established. When the DLS setting is completed, from this time point, the STA1 and the STA2 can respectively perform the mutual data sending by using both the path via the AP and the direct link path as options. The subsequent processing is performed in parallel with the data sending and reception.

1b. The Channel Update Decision Processing

As described above, the channel update decision processing is the processing of determining which path is suitable to be used for the communication with the other party's terminal by using the information related to the transmission quality of the direct link path and the information related to the transmission quality of the path via the AP and deciding the path update with respect to the more appropriate path.

This channel update decision processing is performed in parallel with the normal data sending and reception. The terminal on the sending side (according to the present embodiment, the STA1) takes the initiative to check the respective transmission characteristics of the path via the AP (STA1 [symbol] AP [symbol] STA2) and the direct link path (STA1 [symbol] STA2) for evaluation. Although not specified according to the embodiment of the present invention, the following procedure is considerable as an example.

First, the STA1 is operated in a coordinated manner with the STA2, and a reception signal intensity (RCPI) of a probe traffic for the test sent through the path via the AP is measured and reported. By peeping the packets from the STA1 [symbol] the AP and measuring the transmission channel quality information in the direct link from the packets from the AP [symbol] the STA2, the STA2 can obtain transmission channel quality information in the second half of the path via the AP.

Subsequently, on the other hand, a probe traffic for the test is sent from the STA2 to the STA1 and measured, and it is accordingly obtain transmission channel quality information in the first half of the path via the AP. After that, modulations in accordance with the measurement results for the respective channels are estimated to calculate expected throughputs. Finally, by comparing the expected throughputs calculated for the respective channels, the STA1 decides the channel suitable to the communication at the moment.

Similarly as in this example, the suitable channel is updated, and in a case where the decided channel is different from the channel currently in use, the STA1 advances to the channel switch processing.

1c. The Existing Channel Trailing End Data Sending Processing (Sending Side)

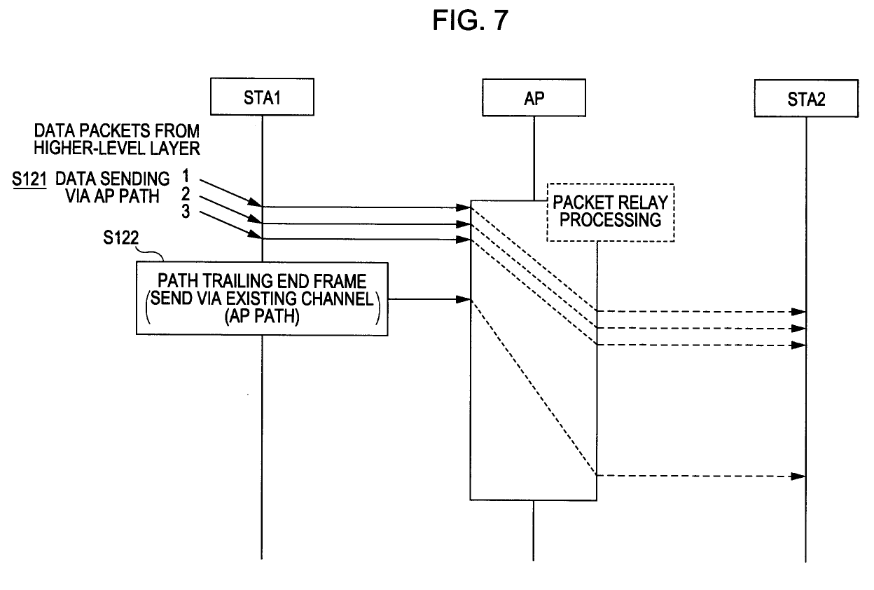

The existing channel trailing end data sending processing is a processing of notifying the reception side that this is the last data sent by the data sending side by using the existing channel. This processing will be described with reference to FIG. 7. FIG. 7 is an explanatory diagram for describing the communication sequence between the devices in the existing channel trailing end data sending processing according to the present embodiment and the processing. From the left, the following devices are illustrated.

The wireless communication device (STA1) functioning as the data sending terminal;

The access point (AP) functioning as the communication relay device; and

The wireless communication device (STA2) functioning as the data receiving terminal.

It should be noted that at the time point of the execution of this existing channel trailing end data sending processing, the STA1 utilizes the path via the AP to perform the data sending to the STA2. As shown in step S121, packet frames 1, 2, and 3 are sent by using the path via the AP. The access point (AP) shown in the drawing executes the packet relay processing. The dotted line in the AP shown in the drawing represents the relay processing. It should be noted that in the drawing, the path via the AP is abbreviated as “AP path”, and the direct link path is abbreviated as “direct path”.

When the switch to the direct link path is decided in the above-mentioned channel update decision processing, in step S121, after the STA1 finishes sending the last data frame (frame 3) to the STA2, in step S122, the STA1 sends a “path trailing end” frame the existing channel (path via AP). The present frame is not a management frame but is the data frame including the signaling information at a higher-level layer than the 802.11 MAC layer.

After this existing channel trailing end data sending processing, the flow is shifted to (d) the channel switch request/response processing.

1d. The Channel Switch Request/Response Processing)

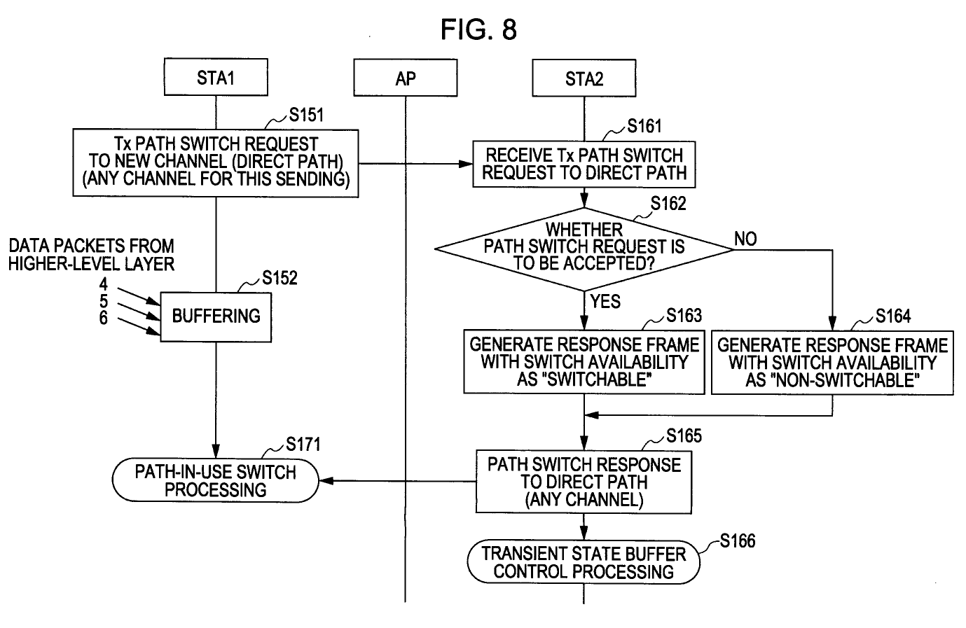

The channel switch request/response processing is a processing in which the data sending side shows an intention to change the channel used for the data sending and receives a response from the reception side. This processing will be described with reference to FIG. 8. FIG. 8 is an explanatory diagram for describing the communication sequence between the devices in the channel switch request/response processing according to the present embodiment and the processing. From the left, the following devices are illustrated.

The wireless communication device (STA1) functioning as the data sending terminal;

The access point (AP) functioning as the communication relay device; and

The wireless communication device (STA2) functioning as the data receiving terminal.

The STA1 on the data sending side sends a “Tx path switch (path switch) request” frame in step S151. The “Tx path switch request” frame is a frame for the communication device on the data sending side to notify the communication device on the data receiving side on the intention for the change of the data sending channel. This frame is not a management frame but is the data frame including the signaling information at a higher-level layer than the 802.11 MAC layer. This frame may be sent by utilizing either the direct link path or the path via the AP.

After this, the STA1 on the data sending side does not perform the data sending until a “Tx path switch response” frame from the STA2 on the data receiving side is received. The data packets descending from the higher-level layer during that period are buffered in a memory inside the STA1. As shown in step S152, data packets 4, 5, and 6 descending from the higher-level layer are buffered in the memory inside the STA1. Therefore, after the “path switch request” frame is sent in step S151, until the buffering is cancelled, the STA1 stops the data sending.

On the other hand, the STA2 on the data receiving side receives a “Tx path switch (path switch) request” frame from the STA1 in step S161. In step S162, the contents of this frame is interpreted to decide whether the path switch request is accepted or not. Then, the processing in accordance with the decision is performed.

In a case where it is decided that the path switch request is accepted, the flow advances to step S163, and the “Tx path switch response” frame storing information indicating that the path switch is “acceptable” is generated, and in step S165, the frame is sent to STA1. This frame is not a management frame similar to the path switch request but is the data frame including the signaling information at a higher-level layer than the 802.11 MAC layer. This frame may be sent by utilizing either the direct link path or the path via the AP.

On the other hand, in step S162, In a case where it is decided that the path switch request is not accepted, the flow advances to step S164, and the “Tx path switch response” frame storing information indicating that the path switch is “non-acceptable” is generated, and the frame is sent in step S165 to the STA1.

The STA1 on the data sending side stands by to receive the “Tx path switch response” frame from the STA2, and in step S171, the flow is shifted to the path-in-use switch processing.

After the “TTx path switch response” is sent in step S165, the STA2 on the data receiving side starts the transient state buffer control processing in step S166.

1e. The Path-In-Use Switch Processing (Sending Side)

The path-in-use switch processing (sending side) is a processing in which the data sending side actually switches the channel used for the data sending and starts to send the data in a new channel in response to the path switch acceptance reply from the data reception side.

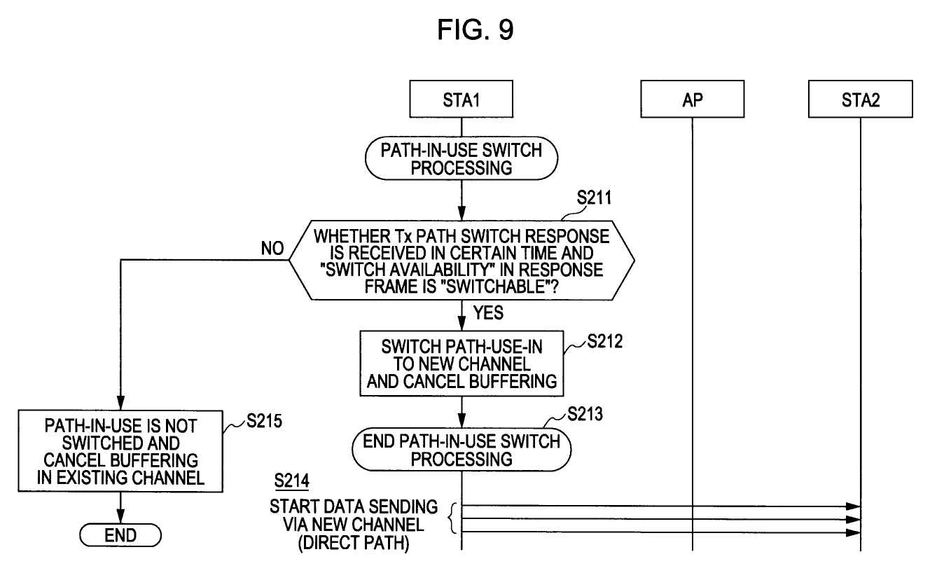

This processing will be described with reference to FIG. 9. FIG. 9 is an explanatory diagram for describing the communication sequence between the devices in the path-in-use switch processing according to the present embodiment and the processing. From the left, the following devices are illustrated.

The wireless communication device (STA1) functioning as the data sending terminal;

The access point (AP) functioning as the communication relay device; and

The wireless communication device (STA2) functioning as the data receiving terminal.

In step S211, it is determined whether or not the STA1 functioning as the device on the data sending side receives the “Tx path switch response” frame storing the information indicating that the path switch is “acceptable” from the STA2 functioning as the device on the data receiving side in a previously set period of time. In a case where the STA1 can receive the frame, the flow advances to step S212, and the path-in-use switch processing is executed, and the buffering is cancelled. In step S213, the path-in-use switch processing is completed. In step S214, the pieces of the buffered data (the packets 4, 5, and 6 buffered in step S152 of FIG. 8) are sequentially sent. In the present example, by switching from the path via the AP to the direct link path, the buffered data (the packets 4, 5, and 6) are sequentially sent.

On the other hand, in step S211, in a case where the STA1 does not receive the “Tx path switch response” frame storing the information indicating that the path switch is “acceptable” in the previously set period of time, the flow advances to step S215. In step S215, the path switch is not executed, and by utilizing the present path (path via AP) as it is, the pieces of the buffered data are sequentially sent. That is, the buffering is cancelled, and the data sending in the existing channel is resumed. By utilizing the present path (path via AP) as it is, the pieces of the buffered data (the packets 4, 5, and 6) are sequentially sent. That is, the buffering is cancelled, and the data sending in the existing channel is resumed.

1f. The Transient State Buffer Control Processing (Receiving Side)

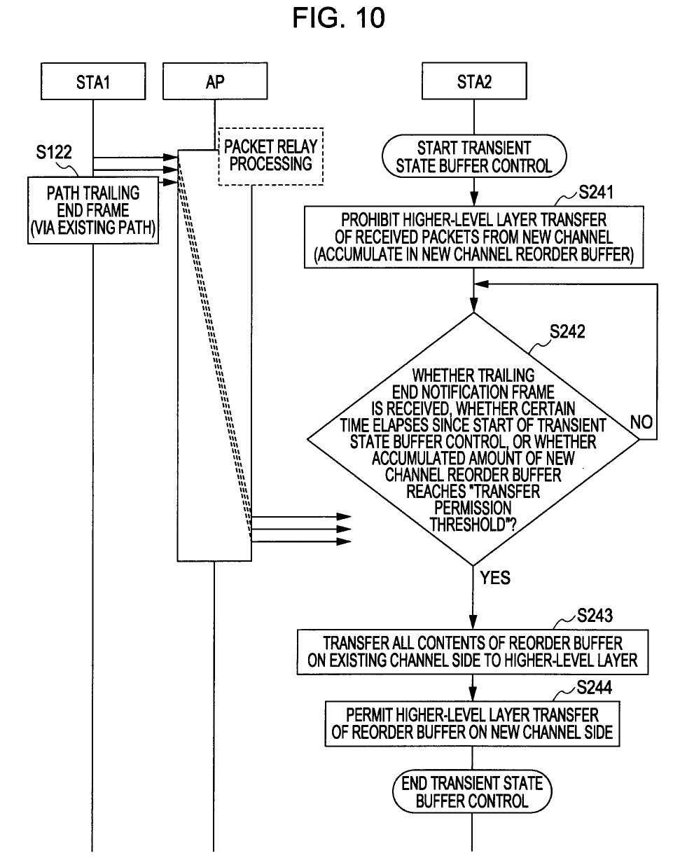

The transient state buffer control processing is a transient processing in which the receiving side which accepts the path switch determines that the channel is completely switched as the last data using the existing channel arrives up to the start of the operation of transferring the received data in the new channel to the higher-level layer as the normal operation. This processing will be described with reference to FIG. 10. FIG. 10 is an explanatory diagram for describing the communication sequence between the devices in the transient state buffer control processing according to the present embodiment and the processing. From the left, the following devices are illustrated.

The wireless communication device (STA1) functioning as the data sending terminal;

The access point (AP) functioning as the communication relay device; and

The wireless communication device (STA2) functioning as the data receiving terminal.

The STA2 on the data receiving side stands by for the arrival of the “path trailing end” frame from the STA1 after the sending processing for the “Tx path switch response” in step S165 described in the above-described flow of FIG. 8 is executed.

It should be noted that the sending of the “Tx path switch request” frame from the data sending side (in step S151 of FIG. 8) may be performed in either the existing channel (in the present example, the path via the AP)or the new channel (in the present example, the direct link path). The sending of the “Tx path switch request” frame is performed in the new channel (direct link path), a case may occur in which the “Tx path switch request” frame arrives at the STA2 earlier than the “path trailing end” frame (sent in step S122 of FIG. 7) sent in the existing channel (in the present example, the path via the AP), and the STA2 sends the “Tx path switch response”.

In this case, it is expected that the data frame in the new channel arrives after the response sending, but at this time point, it is not clear that the arrival of the data frame in the existing channel is yet completely finished. This is because in a case where the path switch request is set in a path different from the existing channel, the request frame may overtake the data.

Therefore, while the STA2 on the data receiving side waits for the trailing end frame from the existing channel, in step S241 shown in FIG. 10, the STA2 continues the transfer of the data packets arriving at the reception reorder buffer for the existing channel to the higher-level layer but prohibits the transfer of the data packets arriving at the reception reorder buffer for the new channel to the higher-level layer and continues the data accumulation.

As described above while referring to FIG. 3, the communication device has the reorder buffer corresponding to the communication channel (path). In the present example, the packets received via the existing channel (path via AP) are accumulated in the reorder buffer for the existing channel, and the packets received via the new channel (direct link path) are accumulated in the reorder buffer for the new channel.

In step S242, the STA2 on the data receiving side determines whether or not one of the following conditions is satisfied.
(a) The trailing end frame is received from the existing channel.
(b) The previously set time elapses since the transient state buffer control start (sending of the “Tx path switch response”).
(c) The received data accumulation amount in the reorder buffer for the new channel reaches the previously set threshold (transfer permission threshold).

In a case where one of the above-mentioned conditions is satisfied, the flow advances to step S243. In a case where none of the above-mentioned conditions is satisfied, the processing in step S241 is continued. That is, the transfer of the data packets arriving at the reception reorder buffer for the existing channel to the higher-level layer is continued, and the transfer of the data packets arriving at the reception reorder buffer from the new channel to the higher-level layer is prohibited and the data accumulation is continued.

In a case where one of the above-mentioned conditions is satisfied, the flow advances to step S243, and all the accumulated data in the reorder buffer for the existing channel is transferred to the higher-level layer. That is, the data is provided to an application layer which for example executes a processing on the received data. It should be noted that even when the remaining packets exist in a state where the packets are not all together, the accumulated packets are collectively transferred to the higher-level layer. After that, the flow advances to step S244, and the transfer prohibition of the data frames accumulated in the reorder buffer for the new channel to the higher-level layer is cancelled, and the transfer to the higher-level layer is started.

Through the above-mentioned processing, the STA2 on the data receiving side can provide the packets to the higher-level layer while maintaining the order of the sending packets even when the path switch is generated. That is, it is possible to secure the order property of the sending and receiving data.

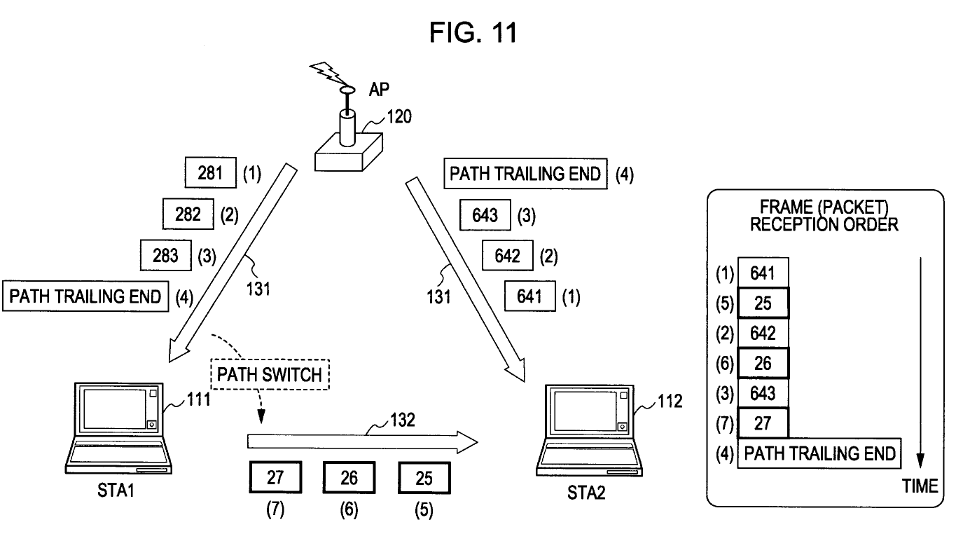

By using the specific example, securing of the order property realized through the processing according to the embodiment of the present invention will be described. FIG. 11 shows the following devices.

A wireless communication device functioning as the data sending terminal: STA1, 111.

A wireless communication device functioning as the data receiving terminal: STA2, 112.

An access point functioning as the communication relay device: AP, 120.

It should be noted that the STA1, 111 utilizes a path 131 via the AP to perform data sending to the STA2, 112. By changing this existing channel to a direct link path 132 which is a new channel, the data sending is continued.

FIG. 11 shows an example of the packet sending order before and after the switch from the path 131 via the AP to the direct link path 132. Numerals written in the respective packets [25 to 27], [281 to 283], and [641 to 643] are sequence numbers recorded in the MAC headers of the packets. [Path trailing end] indicates the path trailing end frame in the existing channel (the path 131 via the AP) sent by the STA1, 111.

As described above while referring to FIG. 4, the sequence number set in the MAC header is set by the device which performs the data sending. For example, in the configuration shown in FIG. 11, in a case where the wireless communication device (STA2) 112 performs the data reception from the wireless communication device (STA1) 111 via the direct link path 132, the sequence number set in the MAC header by the wireless communication device (STA1) 111 is set for the received packet.

The sequence numbers with respect to the packets sent by utilizing the direct link path by the wireless communication device (STA1) 111 are [25 to 27].

Also, the sequence numbers with respect to the packets sent by utilizing the path 131 via the AP by the wireless communication device (STA1) 111 are [281 to 283]. However, these packets are written into new sequence numbers [641 to 643] in the AP 120. That is, in a case where the data reception is performed from the wireless communication device (STA1) 111 via the access point (AP) 120 through the path 131 via the AP, the sequence number set in the MAC header by the access point (AP) 120 is set for the received packet.

In this manner, the sequence numbers for the MAC layer are independent for each communication path. In the wireless communication device (STA1) 111, the sequence number for the AP sent from the wireless communication device (STA1) 111 and the sequence number for the direct link are set to have the consecutive numbers, but the sequence numbers for the MAC header are newly set again by the AP at the time of passing through the AP. As a result, the sequence numbers for the two paths received by the STA are irrelevant sequence numbers.

For reference, FIG. 11 shows the order in which the STA1 actually sends the frames by way of numbers in brackets (1) to (7) next to the respective frames (packets). It should be noted that originally, the “Tx path switch request” frame exists between the path trailing end frame (4) and the first frame in the new channel (5), which is however omitted in the present drawing.

As the path switch response is immediately sent with respect to the request, the path trailing end frame in the existing channel (the path 131 via the AP) may not come earlier than the frame in the new channel (the direct link path 132) in some cases.

In the example shown in FIG. 11, in the sending order (1) to (7) of the frames (packets) by the STA1, (1) to (4) are sent through the path via the AP, and (5) to (7) are sent through the direct link path. With respect to this frame (packet) sending order (1) to (7), a reception order of the frames (packets) by the STA2 is as follows.
(1) 641 (via AP)
(5) 25 (direct link)
(2) 642 (via AP)
(6) 26 (direct link)
(3) 643 (via AP)
(7) 27 (direct link)
(4) The path trailing end frame (via AP)

The frames in the existing channel and the new channel are mixed as shown in the order.

As described above, the sequence number set for the MAC header of the received packet is the sequence number inherent to the path. Thus, the STA2 does not determine the original packet sending order by using this sequence number as it is.

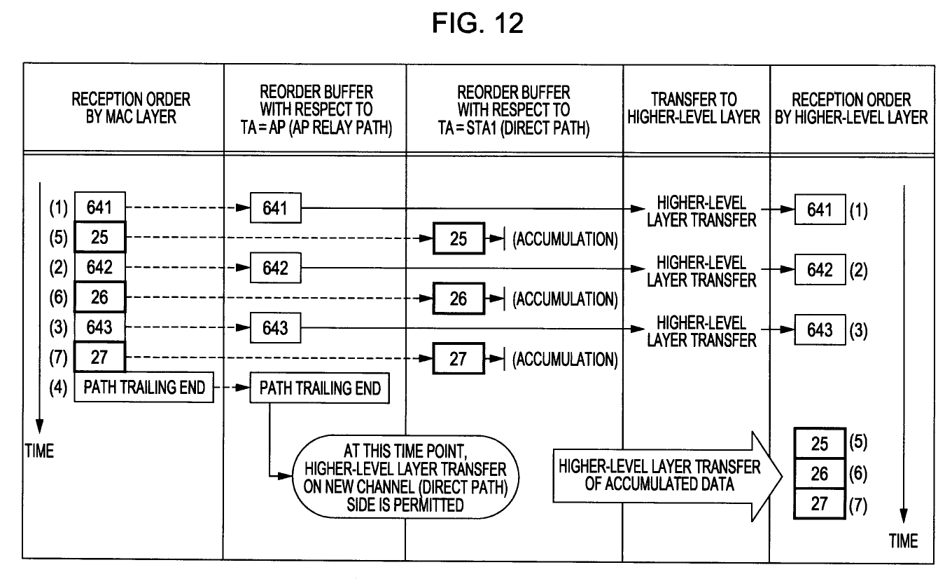

FIG. 12 shows a processing inside the STA2 in a case where the present embodiment is used, that is, a detailed processing example of the transient state buffer control processing. FIG. 12 shows five items as to the STA2 functioning as the data receiving device.

The order of the frames (packets) received by the MAC layer

The accumulation order of the frames (packets) in the reorder buffer corresponding to the path via the AP

The accumulation order of the frames (packets) in the reorder buffer corresponding to the direct link path

The transfer control on the higher-level layer (processing of the control unit)

The reception order of the frames (packets) in the higher-level layer

The order of the frames (packets) received by the MAC layer is similar to the case described with reference to FIG. 11.
(1) 641 (via AP)
(5) 25 (direct link)
(2) 642 (via AP)
(6) 26 (direct link)
(3) 643 (via AP)
(7) 27 (direct link)
(4) The path trailing end frame (via AP)

The frames in the existing channel and the new channel are mixed as shown in the order.

These packets (1) to (7) are accumulated in the following reorder buffers inherent to the two paths while following the sequence number set in the MAC header.

The reorder buffer corresponding to the path via the AP; and

The reorder buffer corresponding to the direct link path.

As shown in FIG. 12, in the reorder buffer corresponding to the path via the AP, the following packets received by the STA2 through the path via the AP are sequentially accumulated.
(1) 641 (via AP)
(2) 642 (via AP)
(3) 643 (via AP)
(4) The path trailing end frame (via AP)

Also, in the reorder buffer corresponding to the direct link path, the following packets received by the STA2 through the direct link path are sequentially accumulated.
(5) 25 (direct link)
(6) 26 (direct link)
(7) 27 (direct link)

As the STA2 sends the path switch acceptance response frame in the direct path to the STA1 (step S165 of FIG. 8), the STA2 waiting for the path trailing end frame prohibits the transfer of the data accumulated in the reorder buffer corresponding to the direct link path which is the new channel to the higher-level layer and continues the packet accumulation.

On the other hand, the transfer of the packets stored in the reorder buffer corresponding to the path via the AP which is the existing channel to the higher-level layer is appropriately continued.

When the STA2 detects the arrival of the “path trailing end” frame sent in the existing channel, the STA2 accordingly determines that the data frame in the existing channel will not come thereafter and uses this as triggers for the batch transfer of the reorder buffer in the existing channel and the higher-level layer transfer start for the reorder buffer for the new channel.

First, after all the pieces of data up to the trailing end in the existing channel are transferred, the data frames in the new channel are transferred to the higher-level layer. It should be noted that these controls are executed in the control unit of the communication processing device (STA2).

As a result, as shown in the right end of FIG. 12, the packet order received by the higher-level layer is as follows.
(1) 641 (via AP)
(2) 642 (via AP)
(3) 643 (via AP)
(5) 25 (direct link)
(6) 26 (direct link)
(7) 27 (direct link)

Therefore, it is possible to receive the packets in the order matched with the sending order of the STA1 on the sending side. It should be noted that the path trailing end frame only indicates the path trailing end and may thus be discarded without being transferred to the higher-level layer.

It should be noted that for measures in a case where the path trailing end frame is lost in the wireless section, after the STA2 sends the “Tx path switch response” frame, if the path trailing end frame is not received for a certain period of time, a processing similar to that performed when the path trailing end frame is received is performed. It should be noted that this time should be set to have a sufficient length to be elapsed after the switch request. Also, when the reorder buffer for the new channel reaches the “transfer permission threshold”, an operation similar to the above-mentioned determination is performed. For example, the transfer permission threshold is set as the maximum amount of the reorder buffer.

It should be noted that according to the above-mentioned embodiment, although the example has been described in which the existing transmission channel is the path via the AP and the new channel is the direct link path, even when the path switch case oppose to the present embodiment in which the existing channel is the direct link path and the new channel is the path via the AP, the processing following the embodiment of the present invention can be applied.

### Second Embodiment

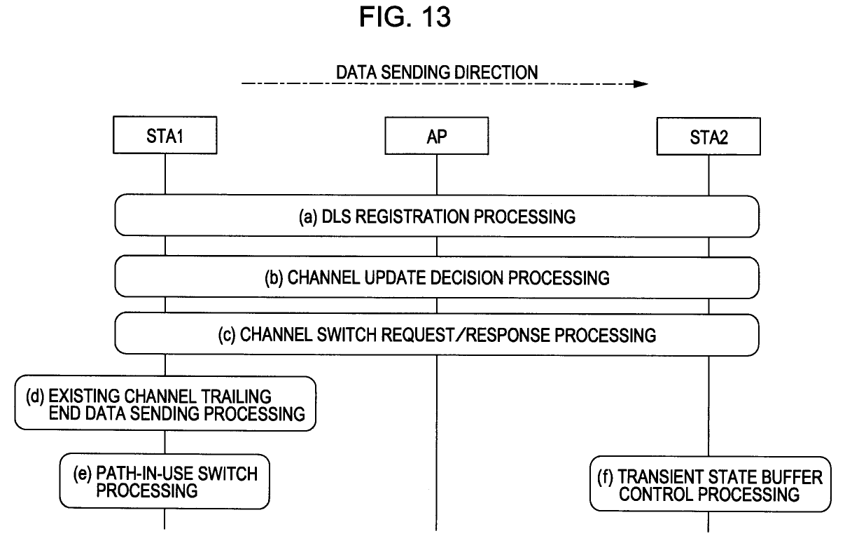

The channel update decision processing described according to the first embodiment has been described as an example executed on the STA1 on the data sending side. Next, as a second embodiment 2, a processing example in which the STA2 on the data receiving side executes the channel update decision processing will be described. According to the present second embodiment, the STA2 on the data receiving side decides the path switch and issues the request. In this case, the overall flow is a sequence shown in FIG. 13 instead of FIG. 5.

In the sequence following the present embodiment, as shown in FIG. 13, the following processings are performed.
(a) The DLS registration processing
(b) The channel update decision processing

Through these two processing, the communication channel (path) switch is decided, and thereafter, the following processings are performed.
(c) The channel switch request/response processing
(d) The existing channel trailing end data sending processing (sending side)
(e) The path-in-use switch processing (sending side)
(f) The transient state buffer control processing (receiving side)

Through these processing, the path switch is completed.

A difference from the processing previously described with reference to FIG. 5 resides in that (c) The channel switch request/response processing and (d) The existing channel trailing end data sending processing (sending side) are interchanged.

2a. The DLS Registration Processing According to the Second Embodiment

In the DLS registration processing according to the second embodiment, the basic processing is similar to the first embodiment.

2b. The Channel Update Decision Processing According to the Second Embodiment

(b) The channel update decision processing described according to the first embodiment is described as the example in which the processing is executed in the STA1 on the data sending side. According to the present second embodiment, the STA2 on the data receiving side performs the channel update decision processing. The reception side terminal (STA2) takes initiative to check the respective transmission characteristics of the path via the AP (STA1 [symbol] AP [symbol] STA2) and the direct link path (STA1 [symbol] STA2) for evaluation. On the reception side too, through a similar processing to that of the first embodiment, it is possible to estimate the transmission quality of the respective paths.

2c. The Channel Switch Processing According to the Second Embodiment

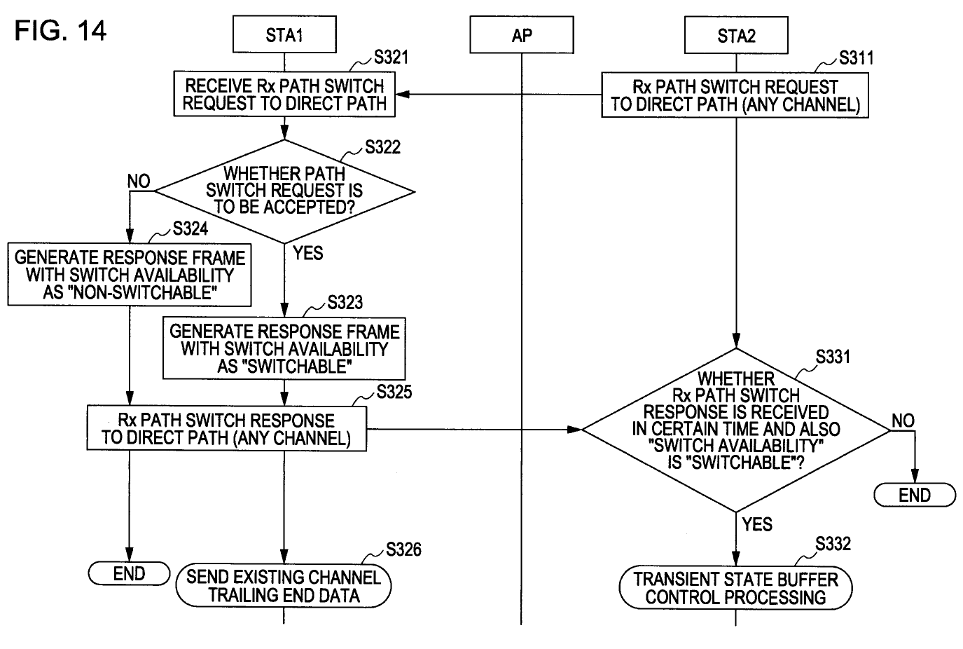

The channel switch processing according to the second embodiment will be described with reference to FIG. 14.

FIG. 14 is an explanatory diagram for describing the communication sequence between the devices in the channel switch processing according to the present embodiment and the processing. From the left, the following devices are illustrated.

The wireless communication device (STA1) functioning as the data sending terminal;

The access point (AP) functioning as the communication relay device; and

The wireless communication device (STA2) functioning as the data receiving terminal.

It should be noted that at the time point of the execution start for this channel switch processing, the STA1 utilizes the path via the AP to perform the data sending to the STA2. According to the present embodiment, the STA2 on the data receiving side decides the switch to the direct link path in the channel update decision processing. First, the STA2 on the data receiving side sends an “Rx path switch request” frame in step S311 to the STA1 on the data sending side.

The “Rx path switch request” frame is a frame for the communication device on the data receiving side to notify the communication device on the data sending side on the intention for the change of the data sending channel. This frame is not a management frame but is the data frame including the signaling information at a higher-level layer than the 802.11 MAC layer. According to the present embodiment, the sending channel for this frame may be either the direct link path or the path via the AP. After this, the STA2 waits for the “Rx path switch response” frame from the STA1.

The STA1 receives the “Rx path switch request” frame from the STA2 in step S321. In step S322, the contents of this frame is interpreted to decide whether the path switch request is accepted or not. Then, the processing in accordance with the decision is performed.

In a case where it is decided that the path switch request is accepted, the flow advances to step S323, and the “Rx path switch response” frame storing the information indicating that the path switch is “acceptable” is generated, and thereafter, after the last data addressed to the STA2 using the current channel is set, in step S325, the “Rx path switch response” frame is sent to the STA2. The sending of this frame may be performed in either the direct link path or the path via the AP.

On the other hand, in step S323, in a case where it is decided that the path switch request is not accepted, the flow advances to step S324, and the “Rx path switch response” frame storing the information indicating that the path switch is “non-acceptable” is generated. After that, in step S325, the “Rx path switch response” frame storing the information indicating that the path switch is “non-acceptable” is sent to the STA2.

After that, in a case where the STA1 sends the “Rx path switch response” frame storing the information indicating that the path switch is “acceptable”, in step S326, the flow is shifted to the sending processing for the trailing end frame in the existing channel. It should be noted that in step S324, in a case where the “Rx path switch response” frame storing the information indicating that the path switch is “non-acceptable” is sent, the data sending in the existing channel is continued.
(d) The existing channel trailing end data sending processing (sending side)
(e) The path-in-use switch processing (sending side)

The above-mentioned subsequent processings are processings substantially similar to those according to the first embodiment.

According to (f) the transient state buffer control processing (receiving side), after the STA2 receives the “Rx path switch response”, arrival of the “path trailing end” frame from the STA1 is waited for, and after that, a management method for the reorder buffer until the trailing end frame arrives and the condition for the transfer start in the new channel to the higher-level layer are similar to those according to the first embodiment.

### Third Embodiment

Next, a third embodiment of the present invention will be described. According to the third embodiment too, the following processings previously described with reference to FIG. 5, that is, the following respective processings are sequentially executed.
(a) The DLS registration processing
(b) The channel update decision processing
(c) The existing channel trailing end data sending processing (sending side)
(d) The channel switch request/response processing
(e) The path-in-use switch processing (sending side)
(f) The transient state buffer control processing (receiving side)

Hereinafter, these processings according to the present embodiment will be described.

3a. The DLS Registration Processing

In the DLS registration processing according to the third embodiment, the basic processing is similar to the first embodiment. According to the present embodiment, a setting is performed in which after the direct link for connecting the STA1 with the STA2 is established, in addition to 802.11 MAC header, an expansion header is assigned to the packets sent and received between two STAs (the STA1 and the STA2).

The expansion header records the following two pieces of information.
(1) The information indicating whether or not the packet is the last data packet in the currently used channel
(2) The information indicating the channel used for sending the present packet

The STA1 on the data sending side records these pieces of information in the expansion header to be sent.

The STA2 on the receiving side interprets this expansion header to be passed to a higher-level layer protocol after deleting the expansion header.

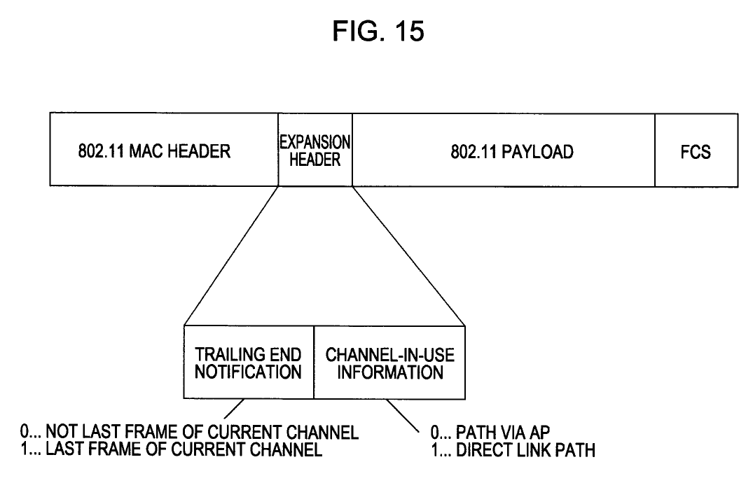

The frame format in a case where the expansion header is included is shown in FIG. 15.

As shown in FIG. 15, for (1) the information indicating whether or not the packet is the last data packet in the currently used channel, the expansion header records the following bits which are thus set, for example.

0=Not the last frame in the current channel

1=The last frame in the current channel

Also, for (2) the information indicating the channel used for sending the present packet, the expansion header records the following bits which are thus set, for example.

0=The path via the AP

1=The direct link path

3b. The Channel Update Decision Processing According to the Third Embodiment
(b) The channel update decision processing is executed as a processing similar to that described according to the first embodiment.

3c. The Existing Channel Trailing End Data Sending Processing (Sending Side)

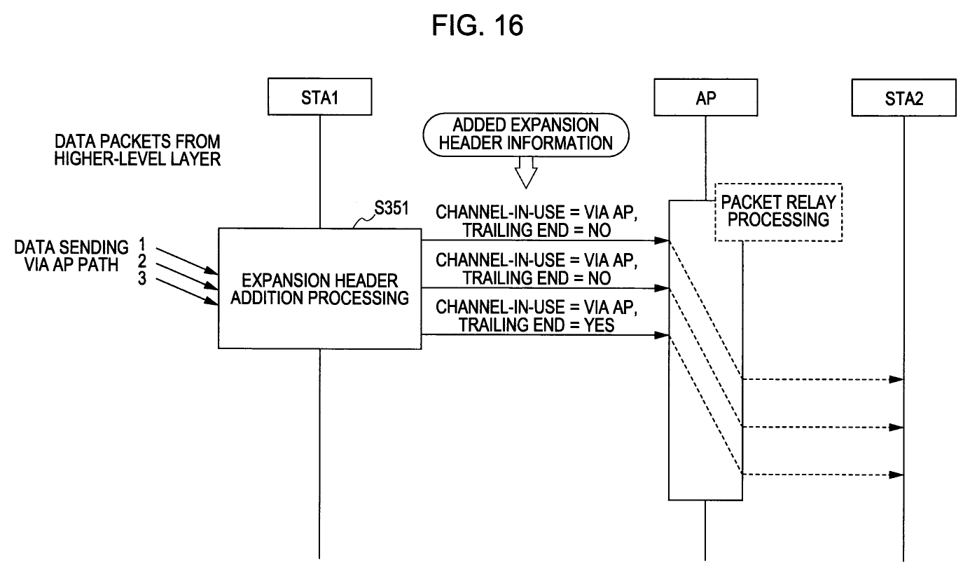

An existing channel trailing end data sending processing according to a fifth embodiment of the present invention will be described with reference to FIG. 16.

FIG. 16 is an explanatory diagram for describing the communication sequence between the devices in the existing channel trailing end data sending processing according to the present embodiment and the processing. From the left, the following devices are illustrated.

The wireless communication device (STA1) functioning as the data sending terminal;

The access point (AP) functioning as the communication relay device; and

The wireless communication device (STA2) functioning as the data receiving terminal.

It should be noted that at the starting time point of this existing channel trailing end data sending processing, the STA1 utilizes the path via the AP to perform the data sending on the STA2. The expansion header is recorded to this sending data and the sending is carried out.

In step S351, on the STA1 side where the data sending is performed, upon the sending of the respective data frames, the expansion header of the data frame as described above while referring to FIG. 15, the STA1 on the data sending side records the following pieces of information in the expansion header to be sent.
(1) The information indicating whether or not the packet is the last data packet in the currently used channel
(2) The information indicating the channel used for sending the present packet In the case of the example shown in FIG. 16, in step S351, for the data frame to which the number “3” is assigned of the data frames 1, 2, and 3 sent in the path via the AP, the data showing the trailing end (the last in the currentn path) frame is set in the expansion header.

In the example shown in FIG. 16, the STA1 records the following additional information in the respective expansion headers and thereafter performs the sending processing.

For the data frame 1 (packet 1), path-in-use=via the AP, trailing end=No.

For the data frame 2 (packet 2), path-in-use=via the AP, trailing end=No.

For the data frame 3 (packet 3), path-in-use=via the AP, trailing end=Yes.

In this manner, according to the present third embodiment, the “path trailing end” frame is not used unlike the first embodiment.

3d. The Channel Switch Request/Response Processing)

3e. The Path-In-Use Switch Processing (Sending Side))

The above-mentioned processings are similar to those according to the first embodiment.

3f. The Transient State Buffer Control Processing)

Next, the transient state buffer control processing according to the present embodiment will be described. The transient state buffer control processing is a transient processing in which the receiving side which accepts the path switch determines that the channel is completely switched as the last data using the existing channel arrives up to the start of the operation of transferring the received data in the new channel to the higher-level layer as the normal operation.

It should be noted that according to the first embodiment previously described, the configuration is adopted in which by applying the reorder buffer inherent to the path, on the basis of the sequence number set in the MAC header, the processing of checking the packet order in the respective paths. This processing is performed in the control unit of the communication processing device, but for the layer, the processing is performed in the MAC layer.

In the present processing example, by applying the LLC layer which is at a level higher than the MAC layer and the reorder buffer which is at a still higher level, the processing of rearranging the order of the packets is performed by utilizing the channel information set in the expansion header for the packets from a plurality of paths.

That is, according to the present third embodiment, separated from the operation of the reorder buffer of the MAC layer, another reorder buffer in the LLC layer is prepared (hereinafter referred to as LLC layer reorder buffer). The transfer in the MAC layer reorder buffer for each of the paths to the higher-level layer is performed when the MAC layer processing is ended. According to the present embodiment, the order property restoration operation is performed in the LLC layer reorder buffer. As described above while referring to FIG. 15, each of the added data packets of the expansion header has the path-in-use information.

In the LLC layer, the packets are sorted out by utilizing the path information recorded in the expansion header and used for the sending. The packets indicating the existing channel are directly transferred to the higher-level layer, and the packets indicating the new channel stand by for the transfer and are sequentially accumulated in the LLC layer reorder buffer. Then, the data frame having the contents where the packet indicates the existing channel and also indicates the trailing end is checked, the accumulation on the new channel side is cancelled, and the transfer of the held packets on the new channel side to the higher-level layer is started.

The principle is similar to the first embodiment, but a difference resides in that the information of which layer is utilized to carry out the reordering processing. When a certain period of time elapses from the start of the transient state buffer control processing or the LLC layer reorder buffer accumulation amount on the new channel side exceeds the “transfer permission threshold”, a similar operation is performed to the case of the above-mentioned trailing end frame reception check.

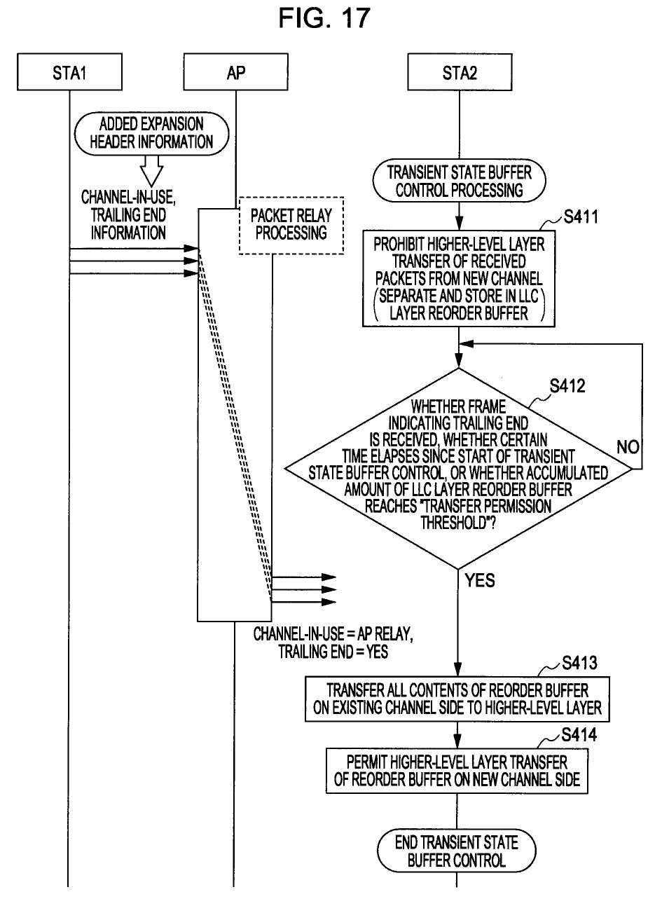

This processing will be described with reference to FIG. 17. FIG. 17 is an explanatory diagram for describing the communication sequence between the devices in the transient state buffer control processing according to the present embodiment and the processing. From the left, the following devices are illustrated.

The wireless communication device (STA1) functioning as the data sending terminal;

The access point (AP) functioning as the communication relay device; and

The wireless communication device (STA2) functioning as the data receiving terminal.

The STA2 on the data receiving side stands by for the arrival of the data frame in which the path trailing end information is set in the expansion header from the STA1 after the sending processing for the “Tx path switch response” in step S165 described in the above-described flow of FIG. 8 is executed.

It should be noted that the sending of the “Tx path switch request” frame from the data sending side (step S151 of FIG. 8) may be performed in either the existing channel (in the present example, the path via the AP) or the new channel (in the present example, the direct link path). In a case where the sending of the “Tx path switch request” frame is performed in the new channel (direct link path), the “Tx path switch request” frame may arrive at the STA2 earlier than the “path trailing end” frame (step sent in S122 of FIG. 7) sent in the existing channel (in the present example, the path via the AP), and the STA2 may send the “Tx path switch response”.

In this case, it is expected that the data frame in the new channel arrives after the response sending, but at this time point, it is not clear that the arrival of the data frame in the existing channel is yet completely finished. This is because in a case where the path switch request is set in a path different from the existing channel, the request frame may overtake the data.

Therefore, in step S411 shown in FIG. 17, while the STA2 on the data receiving side waits for the data frame indicating the trailing end from the existing channel, the STA2 continues the transfer of the data packets received from the existing channel and stored in the LLC layer reorder buffer to the higher-level layer, but prohibits the transfer of the data packets received from the new channel and stored in the LLC layer reorder buffer to the higher-level layer and continues the data accumulation.

It should be noted that as described above, in the MAC layer, the packets received via the existing channel (path via AP) are accumulated in the reorder buffer for the existing channel, and the packets received via the new channel (direct link path) are accumulated in the reorder buffer for the new channel. After that, in the LLC layer, all the received packets are accumulated in the LLC layer reorder buffer. It should be noted that these operations are executed under the control of the control unit.

In step S412, the STA2 on the data receiving side determines whether or not one of the following conditions is satisfied.
(a) The data frame indicating the trailing end is received from the existing channel.
(b) The previously set time elapses since the transient state buffer control start (sending of the “Tx path switch response”).
(c) The received data accumulation amount in the LLC layer reorder buffer reaches the previously set threshold (transfer permission threshold).

In a case where one of the above-mentioned conditions is satisfied, the flow advances to step S413. In a case where none of the above-mentioned conditions is satisfied, the processing in step S411 is continued. That is, the transfer of the data packets received from the existing channel and stored in the LLC layer reorder buffer to the higher-level layer is continued, but the transfer of the data packets received from the new channel and stored in the LLC layer reorder buffer to the higher-level layer is prohibited and the data accumulation is continued.

In a case where one of the above-mentioned conditions is satisfied, the flow advances to step S413, and the received packets in the existing channel (path via AP) of the LLC layer reorder buffer are all transferred to the higher-level layer. That is, the data is provided to the application layer which for example executes a processing on the received data. It should be noted that even when the remaining packets exist in a state where the packets are not all together, the accumulated packets are collectively transferred to the higher-level layer. After that, the flow advances to step S414, and the transfer prohibition for the received packets in the new channel (direct link path) of the LLC layer reorder buffer to the higher-level layer is cancelled, and the higher-level layer transfer is started.

Through the above-mentioned processing, the STA2 on the data receiving side can provide the packets to the higher-level layer while maintaining the order of the sending packets even when the path switch is generated. That is, it is possible to secure the order property of the sending and receiving data.

It should be noted that according to the above-mentioned embodiment, although the example has been described in which the existing transmission channel is the path via the AP and the new channel is the direct link path, even when the path switch case oppose to the present embodiment in which the existing channel is the direct link path and the new channel is the path via the AP, the processing following the embodiment of the present invention can be applied.

### Fourth Embodiment

Next, a fourth embodiment of the present invention will be described. The fourth embodiment is different from the above-mentioned first to third embodiments and is an application example only in the case of such a setting.

The existing channel is the direct link path.

The new channel is the path via the AP.

According to the present fourth embodiment, the STA1 on the data sending side functioning as the communication processing device which performs the sending by applying the direct link path sets the “EOSP” bit in the “QoS Control field” of the 802.11 MAC header of the last sending frame to which the direct link path is applied as [1]. With this setting, it is notified that the relevant frame is the trailing end frame. The frame whose bit is 1 has the same meaning as the “path trailing end” frame.

According to the present embodiment too, the following processings previously described with reference to FIG. 5, that is, the following respective processings are sequentially executed.
(a) The DLS registration processing
(b) The channel update decision processing
(c) The existing channel trailing end data sending processing (sending side)
(d) The channel switch request/response processing
(e) The path-in-use switch processing (sending side)
(f) The transient state buffer control processing (receiving side)

Hereinafter, these processings according to the present embodiment will be described.

4a. The DLS Registration Processing

4b. The Channel Update Decision Processing

This channel update decision processing is similar to that according to the above-mentioned first embodiment. It should be however noted that the present embodiment is targeted to the case only in which the existing channel is the direct link path, and the new channel is the path via the AP.

4c. The Existing Channel Trailing End Data Sending Processing (Sending Side)

In this existing channel trailing end data sending processing, the STA1 on the data sending side substitutes the “path trailing end” frame by the 802.11 MAC header. The STA1 which performs the sending in the direct link path which is the existing channel sets the “EOSP” bit in “QoS Control field” of the 802.11 MAC header in the last frame as 1.

With this setting, the STA2 on the data receiving side is notified that this frame is the trailing end frame. The frame whose bit is 1 has the same meaning as the “path trailing end” frame.

4d. The Channel Switch Request/Response Processing

This processing is also similar to the first embodiment, but the present embodiment is targeted to the case only in which the existing channel is the direct path and the new channel is an AP relay path.

4e. The Path-In-Use Switch Processing (Sending Side))

This processing is similar to the first embodiment.

4f. The Transient State Buffer Control Processing)

This processing is also substantially similar to the first embodiment. A difference resides in that the “path trailing end” frame waited for on the data reception side (STA2) is not an exclusive frame but is the frame whose “EOSP” bit in the “QoS Control field” of the 802.11 MAC header is 1. The present embodiment is targeted to the case only in which the existing channel is the direct path, and the new channel is the AP relay path.

### Fifth Embodiment

Next, a fifth embodiment of the present invention will be described.

According to the first embodiment previously described, if the “Tx path switch request” is sent in the new channel, and also the “path trailing end” frame sent by the STA1 is lost in the channel, unless a long period of time elapses or the reorder buffer for the new channel reaches the reorder buffer maximum amount which is the transfer permission threshold, the STA2 on the receiving side does not provide the data in the new channel to the higher-level layer.

When such a processing is performed, the data reception in the higher-level layer may be delayed, and the response may be slow. According to the present fifth embodiment, the maximum number of the packets in the new channel overtake and arrives earlier until the path trailing end frame transmitted by using the existing channel is sent and actually arrives are estimated. By using this estimation, the threshold for the transfer permit in the reorder buffer for the new channel to the higher-level layer is set to have a smaller value than the maximum value to realize speeding up of the processing.

According to the present embodiment, the following frames are defined and utilized.
(a) “Route specification echo request” frame
(b) “Route specification echo response” frame

(a) The “route specification echo request” frame is a frame for requesting an echo response with respect to the communication other party side.

A field “response channel field” for specifying a channel for sending the echo response is waited for.

The present frame is not a management frame but is the data frame including the signaling information at a higher-level layer than the 802.11 MAC layer.

(b) The “route specification echo response” frame is a response frame sent, when the reception of the “route specification echo request” frame is checked, to the sender of the request.

The response frame is sent in the channel specified by the echo request frame.

Also, the present frame is not a management frame but is the data frame including the signaling information at a higher-level layer than the 802.11 MAC layer.

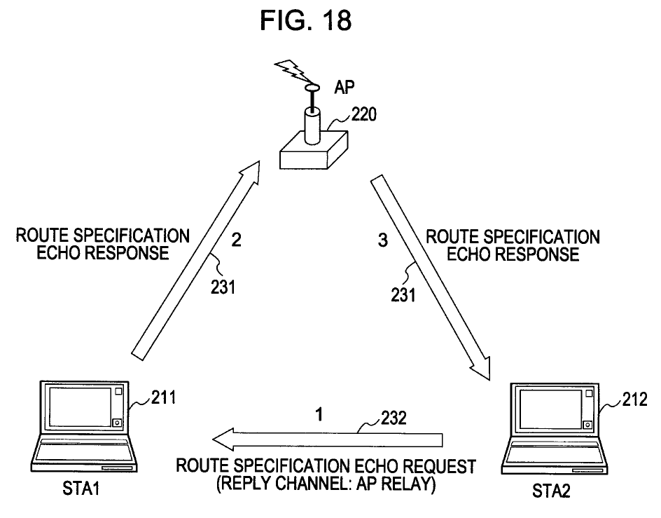

With reference to FIG. 18, the packet transfer time estimation processing by utilizing these frames will be described. FIG. 18 shows the following respective devices.

A wireless communication device functioning as the data sending terminal: STA1, 211

A wireless communication device functioning as the data receiving terminal: STA2, 212

An access point functioning as the communication relay device: AP 220

It should be noted that the STA1, 211 utilizes a path 231 via the AP to perform the data sending with respect to the STA2, 212 and change this existing channel to a direct link path 232 which is a new channel to continue the data sending.

The STA2, 212 functioning as the communication device on the data receiving side sends the “route specification echo request” by specifying the reply channel as the via the AP.

Next, the STA1, 211 receiving the “route specification echo request” replies the “route specification echo response” as a response through the path via the AP as specified.

The STA2, 212 functioning as the communication device on the data receiving side uses this processing to estimate the maximum number of packets in the new channel overtake and arrives earlier until the path trailing end frame transmitted by using the existing channel is sent and actually arrives. By utilizing this estimation, the threshold for performing the transfer permission of the reorder buffer for the new channel to the higher-level layer is set as a smaller value than the maximum value to realize speeding-up of the processing.

According to the fifth present embodiment too, the following processings previously described with reference to FIG. 5, that is, the following respective processings are sequentially executed.
(a) The DLS registration processing
(b) The channel update decision processing
(c) The existing channel trailing end data sending processing (sending side)
(d) The channel switch request/response processing
(e) The path-in-use switch processing (sending side)
(f) The transient state buffer control processing (receiving side)

Hereinafter, these processings according to the present embodiment will be described.

5a. The DLS Registration Processing

This channel update decision processing is similar to that according to the above-mentioned first embodiment.

5b. The Channel Update Decision Processing

A part for evaluating the respective paths is similar to the first embodiment, but according to the present embodiment, at this point, the processing of estimating the overtake amount in the new channel is performed at the same time. That is, the processing is a processing in which the “route specification echo request” frame and the “route specification echo response” frame are applied.

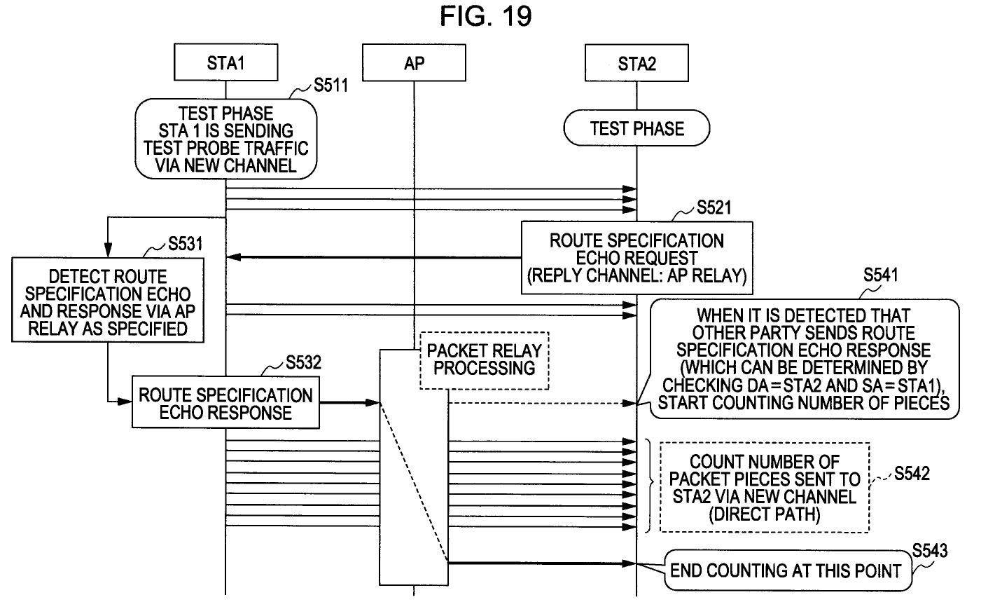

This processing will be described with reference to FIG. 19. FIG. 19 is an explanatory diagram for describing the new channel overtake amount estimation processing executed as the channel update decision processing according to the present embodiment. From the left, the following devices are illustrated.

The wireless communication device (STA1) functioning as the data sending terminal;

The access point (AP) functioning as the communication relay device; and

The wireless communication device (STA2) functioning as the data receiving terminal.

It should be noted that the STA1 and the STA2 at the time point of this processing enters an exclusive mode for the test, and the STA1 continuously sends the probe traffic for the test to the STA2 in the new channel (S511). The STA2 attempting to estimate the overtake amount sends the “route specification echo request” in step S521 to the STA1. The present frame may be sent by using either usable channels. The “reply channel field” in the “route specification echo” frame specifies the existing channel used by the STA1. After that, the STA2 waits for the “route specification echo response” frame to be sent via the existing channel.

The STA1 receives, in step S531, the “route specification echo request” frame and sends the “route specification echo response” frame while following the specified route in step S532.

The STA2 detects that the communication other party (STA1) sends the route specification echo response in step S541. In a case where the existing channel is the path via the AP, the STA2 detects the sending by peeping the “route specification echo response” frame sent in the path of the STA1 [symbol] the AP. This can be determined by determining whether Address 3 is the STA2.

From this time point of the detection, until the “route specification echo response” frame is actually received, the number of packets in which an SA (source address) received from the new channel is the STA1 is counted (S542 to S543).

From this count number, the “new channel overtake estimate amount” is calculated as follows.

When the number of packets counted as described above is N (pieces) and the size of the test packet is S (byte), the overtake amount B in the new channel is found as follows.

B=NS

The STA2 holds this “new channel overtake estimate amount [B]”.

5c. The Existing Channel Trailing End Data Sending Processing (Sending Side)

5d. The Channel Switch Request/Response Processing

5e. The Path-In-Use Switch Processing (Sending Side)

The above processings are similar to those according to the first embodiment.

5f. The Transient State Buffer Control Processing

This processing is also almost similar to that according to the first embodiment, but the condition for allowing the higher-level layer transfer from the reorder buffer for the new channel is one of the following three conditions.

1. When the path trailing end frame in the existing channel is received.

2. When a certain period of time elapses while the path trailing end frame is not received after the “Tx path switch response” frame is sent.

3. When the retention amount of the reorder buffer for the new channel reaches a “transfer permission threshold” described below.

In a case where one of these three conditions is satisfied, the higher-level layer transfer from the reorder buffer for the new channel is permitted.

The conditions 1 and 2 have the same meaning as the description according to the first embodiment, and the first embodiment corresponds to the condition 3 in a case where the “transfer permission threshold” is set as the maximum amount of the reorder buffer.

According to the present embodiment, the “new channel overtake estimate amount” obtained through the channel update decision processing, that is, the above-mentioned “new channel overtake estimate amount [B]” is utilized for the “transfer permission threshold”. The “new channel overtake estimate amount [B]” indicates that the maximum amount of the packets in the new channel until the path trailing end frame arrives earlier. By adding an appropriate margin to this to set the reorder buffer as the “transfer permission threshold”, even when the path trailing end frame does not arrive, the transfer to the higher-level layer can be permitted without waiting for the reach of the maximum amount in the new channel.

In the present processing example, the permission can be accelerated for the higher-level layer transfer from the reorder buffer for the new channel, and the effective processing is realized.

It should be noted that according to the above-mentioned embodiment, although the example has been described in which the existing transmission channel is the path via the AP and the new channel is the direct link path, even when the path switch case oppose to the present embodiment in which the existing channel is the direct link path and the new channel is the path via the AP, the processing following the embodiment of the present invention can be applied.

### Sixth Embodiment

Next, a sixth embodiment will be described. The present sixth embodiment is a processing example in which at the time point when the STA2 on the data receiving side receives the first packet from the new channel, the contents of the reception reorder buffer for the existing channel are collectively transferred to the higher-level layer, and the subsequent received packets in the existing channel are discarded. After this, the transfer is performed only from the reception reorder buffer side in the new channel.

According to the present embodiment too, the following processings previously described with reference to FIG. 5, that is, the following respective processings are sequentially executed.
(a) The DLS registration processing
(b) The channel update decision processing
(c) The existing channel trailing end data sending processing (sending side)
(d) The channel switch request/response processing
(e) The path-in-use switch processing (sending side)
(f) The transient state buffer control processing (receiving side)

Hereinafter, these processings according to the present embodiment will be described.

6a. The DLS Registration Processing

6b. The Channel Update Decision Processing

This channel update decision processing is similar to that according to the above-mentioned first embodiment.

6c. The Existing Channel Trailing End Data Sending Processing (Sending Side)

According to the present embodiment, as being different from other embodiments, the notification processing of the data trailing end in the existing channel on the sending side is not performed.

6d. The Channel Switch Request/Response Processing

6e. The Path-In-Use Switch Processing (Sending Side)

This processing is similar to the first embodiment.

6f. The Transient State Buffer Control Processing

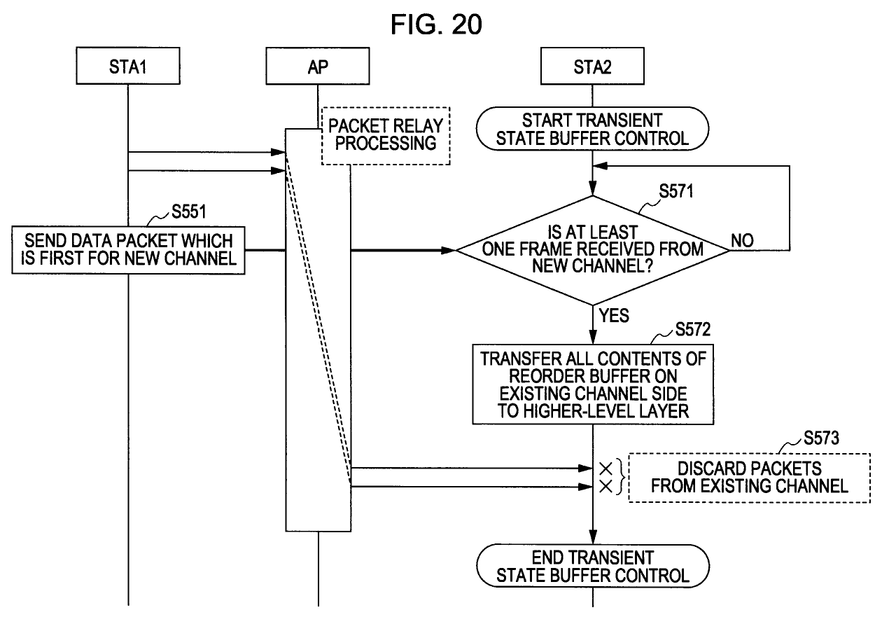

With reference to FIG. 20, the transient state buffer control processing according to the present embodiment will be described. From the left, the following devices are illustrated.

The wireless communication device (STA1) functioning as the data sending terminal;

The access point (AP) functioning as the communication relay device; and

The wireless communication device (STA2) functioning as the data receiving terminal.

The STA2 on the data receiving side waits for the arrival of the data frames from the new channel from the STA1 after the sending processing for the “Tx path switch response” in step S165 described in the above-described flow of FIG. 8 is executed.

The STA1 on the data sending side sends the first data packet in the new channel. The STA2 on the data receiving side determines, in step S571, whether the first data packet in the new channel is received or not, and when it is confirmed that the first data packet is received, the flow advances to step S572.

In step S572, the STA2 collectively transfers the contents of the reception reorder buffer for the existing channel to the higher-level layer and discards the subsequent received packets in the existing channel (step S573). After that, only the transfer of the received reorder buffer side from the new channel is performed.

In this manner, according to the present embodiment, after sending the “Tx path switch response”, the STA2 continues the transfer of the data packets arriving at the reception reorder buffer for the existing channel to the higher-level layer. It should be however noted that when at least one data packet arrives at the reception reorder buffer from the new channel, before the data packet is transferred to the higher-level layer, the contents of the reception reorder buffer for the existing channel at this time are collectively transferred to the higher-level layer, and the subsequent received packets in the existing channel are discarded. After that, only the transfer of the received reorder buffer side from the new channel is performed.

Through the above-mentioned processing, the STA2 on the data receiving side can provide the packets to the higher-level layer while maintaining the order of the sending packets even when the path switch is generated. That is, it is possible to secure the order property of the sending and receiving data.

It should be noted that according to the above-mentioned embodiment, although the example has been described in which the existing transmission channel is the path via the AP and the new channel is the direct link path, even when the path switch case oppose to the present embodiment in which the existing channel is the direct link path and the new channel is the path via the AP, the processing following the embodiment of the present invention can be applied.

In the above, the plurality of embodiments of the present invention have been described. Through the processing of the embodiments of the present invention, for example, the following effects are generated.

By performing the change processing to the communication in which the direct link path is applied, it is possible to improve the transmission efficiency, and at the same time, it is possible to guarantee the similar order property to that in a case where only one side of links is used without assigning the new sequence number to the higher-level layer. Also, upon the path switch, as the stand-by processing is not inserted, it is possible to realize the embodiment with little overhead. Furthermore, upon the path switch, it is possible to avoid the problem that the packets continue to remain in the MAC layer reorder buffer.

In the above, the present invention has been described in detail while referring to the particular embodiments. However, it will be obvious to those skilled in the art that various changes or substitutions of the embodiments may be made without departing from the scope of the invention. That is, the present invention has been disclosed by way of exemplification and should not be construed in a limited manner. In order to determine the gist of the present invention, the claim section should be taken into account.

Also, the series of processings described in the specification can be executed by using hardware, or software, or a compound configuration of both. In a case where the processings are executed by using the software, a program recording the processing sequence is installed into a memory in a computer which is incorporated in dedicated-use hardware, or the program is installed into a general-use computer which can execute various processings to execute the processings. For example, the program is previously recorded in a recording medium. Other than installing the program into the computer from the recording medium, the program is received via a network such as a LAN (Local Area Network) or the internet, and the program can be installed into a recording medium such as built-in hard disk.

It should be noted that the various processings described in the specification may be not only executed in a time series manner while following the description but also executed in a parallel manner or individually in accordance with the device which executes the processing or as the occasion demands. Also, the system in the specification is a logical collective structure of a plurality of devices and is not limited to one in which the respective configuration devices are accommodated in a single package.

The present application contains subject matter related to that disclosed in Japanese Priority Patent Application JP 2008-208843 filed in the Japan Patent Office on Aug. 14, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A wireless communication device comprising:
a control unit configured to perform a processing on communication data; and
a memory storing the communication data,
wherein the control unit has a configuration of performing a processing on data received via a direct link path functioning as a direct communication path with a communication other party and a path via a relay point functioning as a communication path via the relay point, and
wherein the control unit
stores the data received via the respective communication paths in a plurality of reorder buffers corresponding to the communication paths set in the memory,
after a communication path switch decision processing, stores data received from a new channel in a reorder buffer for the new channel and performs a processing of prohibiting transfer of the data to a higher-level layer, and
on condition that data indicating a trailing end frame is received from an existing channel, or a stand-by time elapses, or the data stored in the reorder buffer for the new channel reaches a specified threshold, performs a transfer processing for the data stored in the reorder buffer for the new channel to the higher-level layer.

2. The wireless communication device according to claim 1,
wherein before the transfer processing for the data stored in the reorder buffer for the new channel to the higher-level layer is started, the control unit executes a transfer processing for data stored in a reorder buffer for the existing channel to the higher-level layer.

3. The wireless communication device according to claim 1,
wherein as the communication path switch processing, the control unit sends an acceptance reply to a communication path switch request from the communication other party.

4. The wireless communication device according to claim 1,
wherein as the communication path switch processing, the control unit sends a communication path switch request to the communication other party and receives an acceptance reply.

5. The wireless communication device according to claim 1,
wherein as a processing in a MAC layer, the control unit executes a data storage processing with respect to the plurality of reorder buffers corresponding to the communication paths while following a sequence number in the MAC header included in the received data.

6. The wireless communication device according to claim 5,
wherein as a processing in an LLC layer, the control unit further executes data storage with respect to a reorder buffer corresponding to the LLC layer while following communication path information included in the received data.

7. The wireless communication device according to claim 1,
wherein the control unit measures an overtaking amount of communication data utilizing the new channel with respect to communication data utilizing the existing channel and sets a data amount comparable to the measured overtaking amount as the specified threshold for the data stored in the reorder buffer for the new channel.

8. The wireless communication device according to claim 7,
wherein the control unit sends an echo request frame in which a communication route is specified as a measurement processing of the overtaking amount of the communication data.

9. The wireless communication device according to claim 1,
wherein the data indicating the trailing end frame from the existing channel is a frame in which trailing end information is stored in an expansion header, and wherein the control unit performs a check processing as to whether or not a frame is the frame in which the trailing end information is stored in the expansion header.

10. The wireless communication device according to claim 1,
wherein the data indicating the trailing end frame from the existing channel is a frame in which trailing end information is stored in an EOSP bit in a QoS control field of the 802.11 MAC header, and
wherein the control unit performs a check processing as to whether or not a frame is the frame in which the trailing end information is stored in the EOSP bit.

11. The wireless communication device according to claim 1,
wherein in a case where the data received from the new channel is detected, the control unit executes a transfer processing for data stored in a reorder buffer for the existing channel to the higher-level layer and a processing of discarding data received thereafter from the existing channel.

12. A communication system comprising a plurality of wireless communication devices configured to perform data sending and reception,
wherein the plurality of wireless communication devices which perform a communication processing mutually execute sending and reception of a communication path switch request and an acceptance reply to perform a communication path switch decision, and
wherein the wireless communication device which performs the data reception
stores the data received via respective communication paths in a plurality of reorder buffers corresponding to the communication paths set in a memory,
after a communication path switch decision processing, stores data received from a new channel in a reorder buffer for the new channel and performs a processing of prohibiting transfer of the data to a higher-level layer, and
on condition that data indicating a trailing end frame is received from an existing channel, or a stand-by time elapses, or the data stored in the reorder buffer for the new channel reaches a specified threshold, performs a transfer processing for the data stored in the reorder buffer for the new channel to the higher-level layer.

13. A communication control method executed in a wireless communication device, the method comprising the step of:
performing by a control unit a processing on data received via a direct link path functioning as a direct communication path with a communication other party and a path via a relay point functioning as a communication path via the relay point,
the received data processing step including the steps of
storing the data received via the respective communication paths in a plurality of reorder buffers corresponding to the communication paths set in the memory,
after a communication path switch decision processing, storing data received from a new channel in a reorder buffer for the new channel and performing a processing of prohibiting transfer of the data to a higher-level layer, and
on condition that data indicating a trailing end frame is received from an existing channel, or a stand-by time elapses, or the data stored in the reorder buffer for the new channel reaches a specified threshold, performing a transfer processing for the data stored in the reorder buffer for the new channel to the higher-level layer.

14. A program for executing a processing on communication data in a wireless communication device, the program comprising the step of:
instructing a control unit to perform a processing on data received via a direct link path functioning as a direct communication path with a communication other party and a path via a relay point functioning as a communication path via the relay point,
the received data processing step including the steps of
storing the data received via the respective communication paths in a plurality of reorder buffers corresponding to the communication paths set in the memory,
after a communication path switch decision processing, storing data received from a new channel in a reorder buffer for the new channel and performing a processing of prohibiting transfer of the data to a higher-level layer, and
on condition that data indicating a trailing end frame is received from an existing channel, or a stand-by time elapses, or the data stored in the reorder buffer for the new channel reaches a specified threshold, performing a transfer processing for the data stored in the reorder buffer for the new channel to the higher-level layer.
